(19) United States
(12) Patent Application Publication
(10) Pub. No.: US 2022/0009690 A1
(43) Pub. Date: Jan. 13, 2022

(54) CRUSH RESISTANT PACKAGING MATERIALS AND CONSTRUCTIONS

(71) Applicant: 3M INNOVATIVE PROPERTIES COMPANY, St. Paul, MN (US)

(72) Inventors: Manoj Nirmal, St. Paul, MN (US); Patrick R. Fleming, Lake Elmo, MN (US); Thomas R.J. Corrigan, St. Paul, MN (US); Lisa M. Miller, Spring Valley, WI (US); James R. Prell, Oakdale, MN (US); Sithya S. Khieu, Eden Prairie, MN (US); Daniel J. Hoyord, Chaska, MN (US); Connor M. Pelletier-Sutton, Minneapolis, MN (US)

(21) Appl. No.: 17/294,711

(22) PCT Filed: Nov. 18, 2019
(86) PCT No.: PCT/IB2019/059881

§ 371 Date: May 18, 2021

Related U.S. Application Data
(60) Provisional application No. 62/769,295, filed on Nov. 19, 2018.
(60) Provisional application No. 62/816,809, filed on Mar. 11, 2019.
(60) Provisional application No. 62/930,154, filed on Nov. 4, 2019.

(51) Int. Cl. B65D 81/03; B32B 3/28; B32B 7/05; B32B 7/12

(52) U.S. Cl. CPC B65D 81/03; B32B 3/28; B32B 7/05; B32B 7/12; B32B 2307/546; B32B 2307/732; B32B 2307/56; B32B 2553/023; B32B 2307/54

(57) ABSTRACT

The present disclosure relates to crush resistant packaging materials and/or constructions and to methods of making and using them. Many embodiments provide crush resistance in addition to customizability.

### TECHNICAL FIELD

The present disclosure relates to crush resistant packaging materials and/or constructions and to methods of making and using them. Many embodiments provide crush resistance in addition to customizability.

### BACKGROUND

In 2016, consumers bought more things online than in stores. Consumers Are Now Doing Most of their Shopping Online, Fortune Magazine, Jun. 8, 2016. Specifically, consumers made 51% of their purchases online and 49% in brick-and-mortar stores. Id. One result of this change in consumer behavior is the growing number of packages mailed and delivered each day. Over 13.4 billion packages are delivered to homes and businesses around the world each year (about 5.2 billion by the United States Postal Service, about 3.3 billion by Fed Ex, and about 4.9 billion by UPS). While delivery of non-package mail is decreasing annually, package delivery is growing at a rate of about 8% annually. This growth has resulted in 25% of the U.S. Postal Service's business being package delivery. Washington Examiner, “For every Amazon package it delivers, the Postal Service loses $1.46,” Sep. 1, 2017. Amazon ships about 3 million packages a day, and Alibaba ships about 12 million packages a day.

Further, it is not just businesses shipping packages. The growing Maker culture creates opportunities for individuals to ship their handmade products around the world through websites like Etsy™. Further, the increased focus on sustainability causes many consumers to resell used products on sites like eBay™ rather than throw them into landfills. For example, over 25 million people sell goods on eBay, and over 171 million people buy these goods.

Individuals and businesses shipping these goods basically have two options: (1) boxes including the product to be shipped, optional cushioning, and lots of air; or (2) cushioned pouches or bubble envelopes. Both options have drawbacks.

Shipping boxes are typically made of corrugated fiberboard. Standard corrugated fiberboard includes two, high tensile strength paper layers separated by and glued to a corrugated paper core. This sandwich construction is lightweight yet relatively stiff, making it ideal for forming crush resistant boxes. To form a box, the crush-resistant corrugated material must be creased, die cut, and glued. Such boxes have many advantages, including, for example, the box can stand upright, it is lightweight, stored flat, is recyclable, and is relatively low cost. However, such boxes come in standard sizes that often do not match the size of the item being shipped, so the user must either store numerous sizes, pay more in shipping costs for a box that is too large for the item to be shipped, and/or fill the box with a large amount of filler (often non-recyclable filler) to try to protect the item being shipped from jostling around in a box that is too large. The end result is that products are often mailed in boxes that are not correctly sized, resulting in increased shipping and transit costs and material waste. Further, box assembly requires many steps and additional materials (e.g., shipping tape), such boxes often exhibit poor puncture resistance, and such boxes fail when wet.

Cushioned mailers are good options for mailing items that are not fragile, delicate, and/or breakable. However, they do not provide adequate protection for fragile, delicate, and/or breakable items. Further, such cushioned envelopes are typically provided in a variety of pre-determined sizes to permit selection of a mailer of suitable size for a particular need. In order to accommodate a variety of sizes, it is necessary to maintain an inventory of differently sized mailers. Because mailers are typically of somewhat bulky form in order to provide desired protective performance, maintaining a suitably well-stocked inventory of mailers presents a storage challenge to both individuals and businesses.

### SUMMARY

The inventors of the present disclosure sought to create packaging materials and/or constructions that improve upon and/or remedy one or more of the above disadvantages. The inventors of the present disclosure sought to create a packaging construction that provides sufficient crush protection for an item, which in any embodiment can be an item being shipped or an item to be shipped, and/or crush protection similar to existing offerings while also being easier to use compared to current crush-resistant offerings and/or providing enhanced customization. In some embodiments, the inventors sought to create a packaging material whose size and/or shape could be tailored to the item while still providing adequate protection and/or ease of use. In some such embodiments, the overall cost to ship an item packaged in the packaging materials of the present disclosure may be less or lowered compared to shipping the same item using a box. Further, in some embodiments, less filler material is required, resulting in less waste and a more environmentally friendly shipping option. In some embodiments, the packaging constructions are also at least one of more sustainable, lower cost, and use or require less material, less time, and/or less waste.

Some embodiments of the present disclosure relate to a packaging material, comprising: a first attachment portion having a first major surface and a second major surface; a core portion having a first major surface and a second major surface; the first major surface of the core portion adjacent to the second major surface of the first attachment portion; a stiffening portion having a first major surface and a second major surface, the first major surface of the stiffening portion adjacent to the second major surface of the core portion; and a second attachment portion having a first major surface and a second major surface; the first major surface of the second attachment portion adjacent to the second major surface of the stiffening portion.

Some embodiments of the present disclosure relate to a packaging material, comprising: a first attachment portion having a first major surface and a second major surface; a second attachment portion having a first major surface and a second major surface; and a structural assembly between the first attachment portion and the second attachment portion. In some embodiments the structural assembly is one of a monolithic structure and a multilayer construction. In some embodiments where the structural assembly is a multilayer construction, the structural assembly comprises: a core portion having a first major surface and a second major surface; the first major surface of the core portion adjacent to the second major surface of the first attachment portion; a stiffening portion having a first major surface and a second major surface, the first major surface of the stiffening portion adjacent to the second major surface of the core portion.

Some embodiments of the present disclosure relate to a packaging material, comprising: a multilayer construction that has an initial bending stiffness or flexural rigidity per unit width of less than 0.11 Nm. The bending stiffness per unit width is defined as:

$${S}_{b} = \frac{E * I}{w} = \frac{{FI}^{3}}{48 δ w} ;$$

$$w = width of sample ;$$

$$E = elastic modulus of material ;$$

$$I = Area moment of inertia ;$$

$$F = Applied load ;$$

$$δ = displacement ;$$

$$l = span ;$$

From here on the term bending stiffness refers to bending stiffness per unit width and has units of force times length (e.g. lbf-inch or N-m). The applied load, F, versus displacement, 6, was measured in a 3-pt. bend test configuration, for a 5.08 cm wide sample with a 15.24 cm span, as specified by ASTM D790-17. A loading nose with a radius of 12.7 mm instead of the 5 mm loading nose specified in the ASTM D790-17 test protocol was used. Section 6.1.2.2 of the test method outlines the allowable use of alternative loading noses. The final bending stiffness is at least five times the initial bending stiffness when the packaging material is wrapped around an item at least twice. In some embodiments, the initial bending stiffness is less than 0.06 Nm as measured by ASTM D790-17. In some embodiments, the final bending stiffness is at least ten times the initial bending stiffness when the packaging material is wrapped around an item at least twice. In some embodiments, the final bending stiffness is at least fifteen times the initial bending stiffness when the packaging material is wrapped around an item at least twice.

In some embodiments, the packaging material further includes an adhesive or attachment mechanism between at least a portion of the core portion and the stiffening portion. In some embodiments, the core portion includes at least one of paper, film, plastic, polymeric material, molded pulp, a non-woven material, a woven material, foam, a corrugated material, corrugated paper, natural fibers, polymers, inorganic materials, metals, a lightweight or open structure, a net, a scrim, a web, or combinations thereof. In some embodiments, the packaging material is a corrugated material including a plurality of flutes that are spaced by between about 66 flutes/m and about 591 flutes/m. In some embodiments the core portion is one of a monolithic structure or a multilayer construction. In some embodiments, the core portion has a Flat Crush Resistance of between about 0.05MPa and about 10 MPa when measured according to Tappi 825. In some embodiments, the core portion has a shear modulus of between about 0.3 MPa and about 5 MPa when measured according to ASTM C273. In some embodiments, the core portion has a thickness of between about 0.04 cm and about 2.54 cm.

In some embodiments, the stiffening portion includes at least one of a film, a non-woven, a woven, a net, a mesh, a scrim, a natural fiber, paper, a polymer, plastic, an inorganic material, fiberglass, or a metal, a metal foil, or combinations thereof. In some embodiments, the stiffening portion has a tensile modulus of at least about 100 MPa when measured according to ASTM D828-16. In some embodiments, the stiffening portion has a tensile strength of at least about 0.1 MPa when measured according to ASTM D828-16. In some embodiments, the stiffening portion has a thickness of between about 0.006 mm and about 0.762 mm.

In some embodiments, the core portion and the stiffening portion comprise a structural assembly. In some embodiments, the structural assembly is one of a monolithic unit, a multilayer construction, or a multicomponent construction. In some embodiments, the structural assembly has a tensile modulus of at least 100 MPa when measured according to ASTM D828-16. In some embodiments, the structural assembly has a tensile strength of at least about 0.3 MPa when measured according to ASTM D828-16. In some embodiments, the structural assembly has a shear modulus of between about 0.3 MPa and about 5 MPa when measured according to ASTM C273. In some embodiments, the structural assembly has a flat crush resistance of about 0.05 MPa and about 10 MPa when measured according to Tappi T825. In some embodiments, the structural assembly has a thickness of between about 0.04 cm and about 2.54 cm.

In some embodiments, the first and second attachment portions are the same as one another. In some embodiments, the first and second attachment portions are different than one another. In some embodiments, at least one of the first and second attachment portions include at least one of a cohesive material, a structural adhesive, and/or a mechanical attachment device. In some embodiments, at least one of the first and second attachment portions includes a cohesive material that has at least one of: (a) a tack of less than 30 grams when measured according to ASTM D2979; or (b) less than 20 wt % tackifier. In some embodiments, at least one of the first and second attachment portions includes a cohesive material that has at least one of: (a) a tack of less than 20 grams when measured according to ASTM D2979; or (b) less than 10 wt % tackifier. In some embodiments, the first and second attachment portions have a peel strength (when peeled from one another) of greater than 39.4 gm/cm when measured according to ASTM D1876-08. In some embodiments, at least one of the first and second attachment portions has a shear modulus of greater than 0.3 MPa when measured according to ASTM D1002. In some embodiments, the first and second attachment layers bond to one another in a bonding timescale of between about 0.1 and about 60 seconds. In some embodiments, the first and second attachment layers have a bonding timescale that permits the packaging material to be repositionable. In some embodiments, at least one of the first and second attachment portions have a shear strength of greater than 5 psi when measured according to ASTM D3163-01. In some embodiments, at least one of the first and second attachment portions exhibit clean removal from an item to be wrapped with the packaging material. In some embodiments, at least one of the first or second attachment portions covers or is directly adjacent to at least 10% of the surface area of at least one of the core portion, the stiffening layer, or the structural assembly. In some embodiments, at least one of the first or second attachment portions covers or is directly adjacent to at least 50% of the surface area of at least one of the core portion, the stiffening layer, or the structural assembly. In some embodiments, at least one of the first or second attachment portions covers or is directly adjacent to at least 75% of the surface area of at least one of the core portion, the stiffening layer, or the structural assembly. In some embodiments, at least one of the first or second attachment portions is discontinuous across the surface area of at least one of the core portion, the stiffening layer, or the structural assembly. In some embodiments, the discontinuities have a size of less than 10 times the thickness of the packaging material. In some embodiments, the first and second attachment portions do not substantially adhere, attach, or bond to an item placed adjacent to the packaging material.

In some embodiments, the packaging material further includes segments. In some embodiments, the packaging material further comprises cushioning material or a cushioning layer. In some embodiments, the cushioning material or layer is packaging material as described herein, and favorably a packaging material of claim 40 (with reference to the originally filed claims), wherein the cushioning layer is positioned adjacent to at least one of the core portion or the stiffening portion.

In some embodiments, the packaging material further includes flaps. In some embodiments, the flaps are at least one of: (a) attached or adjacent to a crush-resistant portion including the structural assembly, first attachment portion, and second attachment portion; or (b) formed of the stiffening layer without core portion, first attachment portion, or second attachment portion.

In some embodiments, the packaging material further comprises a release liner and/or separator layer and/or outer layer adjacent to one or both of first and second first attachment portions. Some embodiments include an easy-open mechanism. In some embodiments, the easy-open mechanism is at least one of a pull tab or slit.

In some embodiments, a first layer of packaging material and a second layer of packaging material are directly adjacent to one another to form a packaging construction. The packaging construction includes the first attachment portion of the second layer of packaging material directly adjacent to and/or contacting the second attachment portion of the first layer of packaging material. In some embodiments, the packaging construction has a minimal deflection under load. In some embodiments, the package construction deflects no more than 7.62 cm, or 6.35 cm, or 5.08 cm, or 3.81 cm, or 2.54 cm when under a load of about 18.14 kg. In some embodiments, the package construction deflects between about 0.32 cm and about 7.62 cm when under a load of about 18.14 kg. In some embodiments, the package construction deflects no more than 7.62 cm, or 6.35 cm, or 5.08 cm, or 3.81 cm, or 2.54 cm when under a load of about 22.68. In some embodiments, the package construction deflects between about 0.3175 cm and about 7.62 cm when under a load of about 22.68 kg.

In some embodiments, the unused packaging material has an initial bending stiffness of less than 0.11 Nm as measured by ASTM D790-17; and the packaging construction has a bending stiffness of at least five times the bending stiffness of the packaging material. In some embodiments, the unused packaging material has a bending stiffness of less than 0.06 Nm as measured by ASTM D790-17; and the packaging construction has a bending stiffness of at least ten times the bending stiffness of the packaging material.

In some embodiments, the packaging material is on a roll.

Some embodiments of the present disclosure relate to a method of using the packaging materials described herein. Some methods involve positioning an item on a first piece of packaging material that is sized large enough to wrap around the item twice; rolling the item in the first piece of packaging material so that the first piece of packaging material wraps around the item at least twice to form a packaging construction; and sealing or closing the ends of the packaging construction. It should be understood that “rolling” and “unrolling,” as those terms are used herein, are not necessarily limited to the motion of spinning or wrapping around a single axis but includes other modes of wrapping the packaging material around at least part of the item. Some methods additionally involve positioning the packaging construction on a second piece of the packaging material that is sized large enough to wrap around the packaging construction at least once; and rolling the packaging construction in the second piece of packaging material so that the second piece of packaging material wraps around the packaging construction at least once. In some embodiments, the first and second pieces of packaging material include corrugated material that includes a plurality of flutes and at least one of: (a) at least some of the flutes of the second piece of packaging material are parallel to at least some of the flutes of the first piece of packaging material; or (b) at least some of the flutes of the second piece of packaging material are perpendicular to at least some of the flutes of the first piece of packaging material.

A method of using any of the packaging materials described herein comprising: positioning an item on a first piece of packaging material that is sized large enough to wrap around the item at least once; rolling the item in the first piece of packaging material so that the first piece of packaging material wraps around the item to form a wrapped item; positioning the wrapped item on a second piece of packaging material that is sized large enough to wrap around the wrapped item at least once; rolling the wrapped item in the second piece of packaging material so that the second piece of packaging material wraps around the wrapped item to form a packaging construction; and sealing or closing the ends of the packaging construction.

In some embodiments, the packaging construction forms a generally cylindrical package. In some embodiments, the first and second pieces of packaging material are perpendicular to one another. In some embodiments, the first and second pieces of packaging material include corrugated material that includes a plurality of flutes and at least one of: (a) at least some of the flutes of the second piece of packaging material are parallel to at least some of the flutes of the first piece of packaging material; or (b) at least some of the flutes of the second piece of packaging material are perpendicular to at least some of the flutes of the first piece of packaging material.

Some methods further involve positioning the packaging construction on a third piece of the packaging material that is sized large enough to wrap around the packaging construction at least once; and rolling the packaging construction in the third piece of packaging material so that the third piece of packaging material wraps around the packaging construction at least once. In some embodiments, the third piece of packaging material is perpendicular to at least one of the first or second pieces of packaging material.

In some embodiments, the first, second, and third pieces of packaging material includes corrugated material that includes a plurality of flutes and at least one of: (a) at least some of the flutes of the second piece of packaging material are parallel to at least some of the flutes of the first piece of packaging material; or (b) at least some of the flutes of the second piece of packaging material are perpendicular to at least some of the flutes of the first piece of packaging material; or (c) at least some of the flutes of the third piece of packaging material are parallel to at least some of the flutes of the first or second pieces of packaging material; or (d) at least some of the flutes of the third piece of packaging material are perpendicular to at least some of the flutes of the first or second pieces of packaging material.

### BRIEF DESCRIPTION OF DRAWINGS

In the following detailed description, reference may be made to the accompanying set of drawings that form a part hereof and in which are shown by way of illustration several specific embodiments. It is to be understood that other embodiments are contemplated within the scope of the present disclosure.

FIG. 1A is a schematic, partially exploded, perspective view of one embodiment of a packaging material consistent with the teachings herein.

FIG. 1B is a cross-sectional side view of the packaging material of FIG. 1A.

FIG. 2A is a schematic, partially exploded, perspective view of one embodiment of a packaging material consistent with the teachings herein.

FIG. 2B is a cross-sectional side view of the packaging material of FIG. 2A.

FIG. 3 is a cross-sectional side view of a packaging material of the type generally described herein.

FIG. 4A is a schematic, partially exploded, perspective view of one embodiment of a packaging material consistent with the teachings herein.

FIG. 4B is a cross-sectional side view of the packaging material of FIG. 4A.

FIGS. 5A and 5B are, respectively, perspective and side views of the packaging material of FIGS. 4A and 4B rolled into a tube, cylinder, or roll. FIG. 5C is an exploded view of a portion of the roll of FIG. 5B.

FIG. 6 is a schematic side of view of the packaging construction of FIGS. 5A and 5B when exposed to load or force during, for example, storage or transit.

FIGS. 7A-7E are schematic views of various exemplary adhesive coating patterns.

FIGS. 8A and 8B are photographs showing one exemplary corrugated core portion constructions.

FIG. 9A is a schematic views of an exemplary corrugated core portion or material.

FIG. 9B is a schematic drawing showing one preferred method of rolling the corrugated core portion or material of FIG. 9A.

FIGS. 10A-10C are top view schematics showing an exemplary embodiment of a packaging construction consistent with the teachings herein.

FIG. 11 is a schematic views of an exemplary corrugated core portion or material including segments as well as spaces or gaps.

FIGS. 12A, 12B, 12C, and 12D are all schematic cross-sectional views of exemplary packaging materials taken along the length of a segment, gap, or space in the packaging material.

FIGS. 13A, 13B, and 13C are photographs depicting three different exemplary packaging constructions consistent with the teachings herein.

FIGS. 14A and 14B show two exemplary embodiments of a packaging construction including a handwritten or computer-generated label, respectively.

FIGS. 15A, 15B, and 15C are schematic views of one exemplary method of closing or sealing the upper and lower ends of an exemplary cylindrical packaging construction.

FIGS. 16A, 16B, and 16C are schematic views of one exemplary method of closing or sealing the upper and lower ends of an exemplary cylindrical packaging construction.

FIGS. 17A, 17B, and 17C are schematic views of one exemplary method of closing or sealing the upper and lower ends of an exemplary cylindrical packaging construction. FIG. 17D is an enlarged view up of the upper sealing portion of the packaging construction.

FIGS. 18A and 18B are schematic views showing one exemplary method of wrapping multiple items wrapped using the packaging constructions described herein.

FIGS. 19A and 19B are schematic views showing one exemplary method of opening an exemplary packaging construction of the type generally described herein.

FIGS. 20A through 20D schematically show another exemplary method of opening and removing an item from an exemplary packaging construction of the type generally described herein.

FIGS. 21A and 21B are schematics showing another exemplary method of opening an exemplary packaging construction of the type generally described herein.

FIGS. 22A through 22H schematically show another exemplary method of closing or sealing the upper and lower ends of an exemplary cylindrical packaging construction.

FIGS. 23A through 23F are schematics showing another exemplary packaging construction and/or another exemplary method of forming the packaging construction.

FIG. 24 is a schematic showing still another exemplary packaging construction and/or another exemplary method of forming the packaging construction.

### DETAILED DESCRIPTION

The present disclosure relates generally to packaging materials and/or packaging constructions. Many different embodiments of the packaging materials and/or packaging constructions are described herein. The present disclosure also relates generally to methods of making and using the packaging materials and/or packaging constructions.

The inventors of the present disclosure sought to create packaging materials and constructions that provided size customizable crush resistance, that are easy to use, that save time and/or money, and/or that use less material (and are thus more environmentally friendly). In some embodiments, the materials allow for customization of the package volume. Reducing wasted volume (also referred to as increased spatial efficiency) allows, for example, more packages to be loaded on trucks or airplanes, thereby reducing overall shipping cost and/or saving fuel.

In some embodiments, the material/construction that is capable of going from a relatively flexible state—that is easy to use and capable of being sold or stored in a roll—to a rigid state—that provides excellent crush resistance. The flexibility of an object depends both on its geometry and its material composition. As used in the present application, an object or material is “flexible” if a 5.08 cm by 15.24 cm section, supported at the short edges, has a bending stiffness in at least one direction of less than 0.11 Nm as measured by ASTM D790-17. Some packaging material embodiments have a bending stiffness in at least one direction of less than 0.05 Nm, or less than 0.04, or less than 0.03 Nm as measured by ASTM D790-17 when in their unused form.

In some embodiments, the packaging construction, once formed, has a bending stiffness in at least one direction that is at least 5 times, or at least 6 times, or at least 7 times, or at least 8 times, or at least 9 times, or at least 10 times, or at least 11 times, or at least 12 times, or at least 13 times, or at least 14 times, or at least 15 times the bending stiffness in at least one direction of the packaging material in its single-layer, unused form as measured by ASTM D790-17.

The inventors thus created a flexible packaging material that is capable of being sold in roll or sheet form that can be wrapped around an item. By tightly wrapping the item with the packaging material such that the item is surrounded by at least two layers of the packaging material, a packaging construction is formed that is highly rigid and that provides excellent crush resistance. The first layer of packaging material surrounding the item is in direct contact—and attaches or bonds to—the second layer of packaging material. These features facilitate the formation of the highly rigid packaging construction.

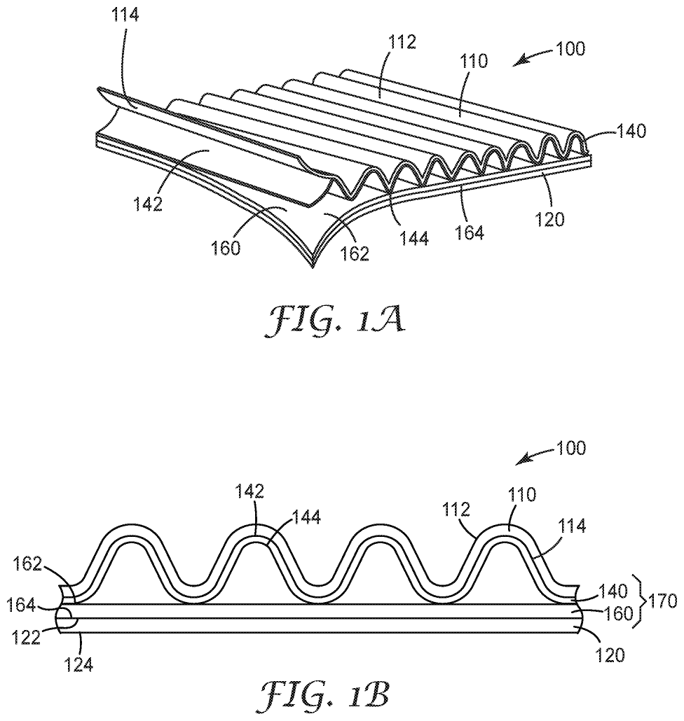

FIG. 1A is a schematic perspective, partially exploded view of an exemplary packaging material consistent with the teachings herein. FIG. 1B shows the packaging material in cross-sectional, side view. Packaging material 100 includes a first attachment portion 110 adjacent to a core portion 140 adjacent to a stiffening portion 160 adjacent to a second attachment portion 120. Each of these four portions works cooperatively to result in a packaging material with the unique properties described herein.

In the embodiment of FIGS. 1A and 1B, first attachment portion 110 is directly adjacent to and/or tracks or generally follows the contours of core layer 140. First attachment portion includes a first (upper) major surface 112 and a second (lower) major surface 114. First major surface 112 is the uppermost upper surface of packaging material 100 while second major surface 114 is adjacent to core layer 140. Second attachment portion 120 includes a first (upper) major surface 122 and a second (lower) major surface 124. First major surface 122 is adjacent to stiffening layer 160 and second major surface 124 is the outermost lower surface of packaging material 100.

Core portion 140 is between first attachment portion 110 and stiffening portion 160. In the embodiment of FIGS. 1A and 1B, core portion 140 is a corrugated material including a plurality of generally parallel ridges 142 and valleys 144. Only portions of first (upper) major surface 162 of stiffening portion 160 are in direct contact with a plurality or some of the valley portions 144 of the corrugated core portion 140.

Stiffening portion 160 includes a first (upper) major surface 162 and a second (lower) major surface 164. First major surface 162 is adjacent to core portion 140, and second major surface 164 is adjacent to second attachment portion 120 (specifically to the first major surface 122 of second attachment portion 120).

The term “structural assembly” 170 is used herein to refer to core portion 140 and stiffening portion 160.

Those of skill in the art will appreciate that many changes may be made to the specific construction shown in FIGS. 1A and 1B. For example, each portion may include multiple layers or a single layer. Also, additional layers or portions may be between the portions or layers shown. For example, an adhesive layer (or other attachment layer) may be between core layer 140 and stiffening layer 160 to hold these two portions or layers firmly together. Further, the drawings are not to scale and the relative thicknesses, shapes, and/or spacing of the layers or portions may differ.

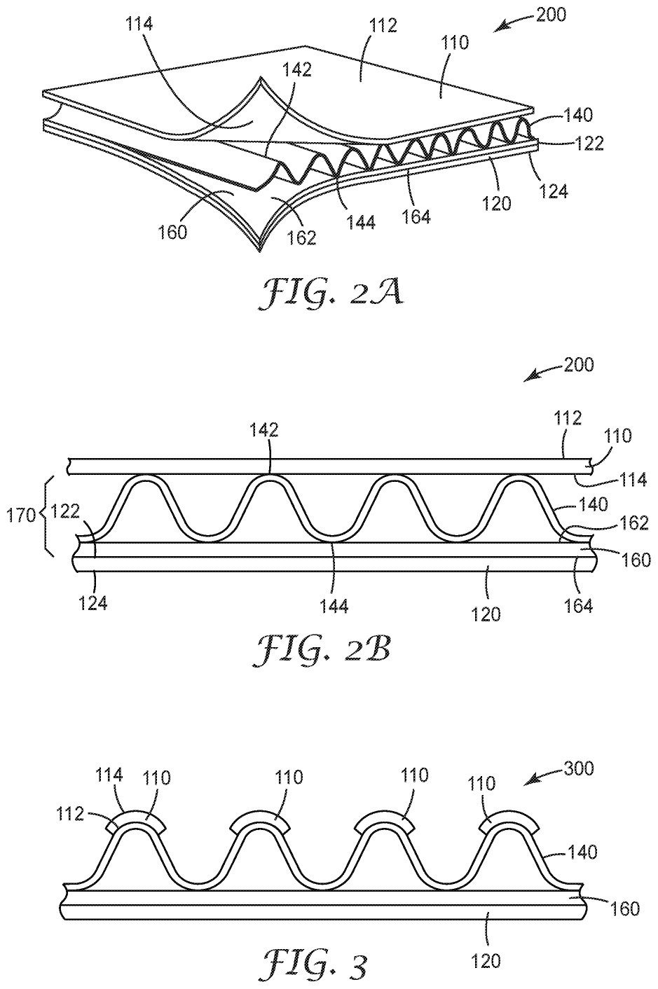

FIGS. 2A and 2B show another embodiment of a packaging material consistent with the teachings herein. The embodiment of FIGS. 2A and 2B is similar to that of FIGS. 1A and 1B except that first attachment portion 110 is a flat layer instead of a layer that generally follows the contours of corrugated core portion 140. As such, only portions of first attachment portion 110 are in direct contact with ridge portions 142 of corrugated core portion 140. Further, some areas of first attachment portion 110 are spaced from, and are thus not in direct contact with, corrugated core portion 140.

Those of skill in the art will appreciate that many changes may be made to the specific construction shown in FIGS. 2A and 2B. Each portion may include multiple layers or a single layer. Additional layers or portions may be between the portions or layers shown. For example, an adhesive layer (or other attachment layer) may be between core layer 140 and stiffening layer 160 to hold these two portions or layers firmly together.

FIG. 3 shows another embodiment of a packaging material consistent with the teachings herein. The embodiment of FIG. 3 is similar to that of FIGS. 1A and 1B except that first attachment portion is only present on ridge portions 142 of corrugated core portion 140. As such, first attachment portion is discontinuous.

Those of skill in the art will appreciate that many changes may be made to the specific construction shown in FIG. 3. Each portion may include multiple layers or a single layer. Additional layers or portions may be between the portions or layers shown. For example, an adhesive layer (or other attachment layer) may be between core layer 140 and stiffening layer 160 to hold these two portions or layers firmly together.

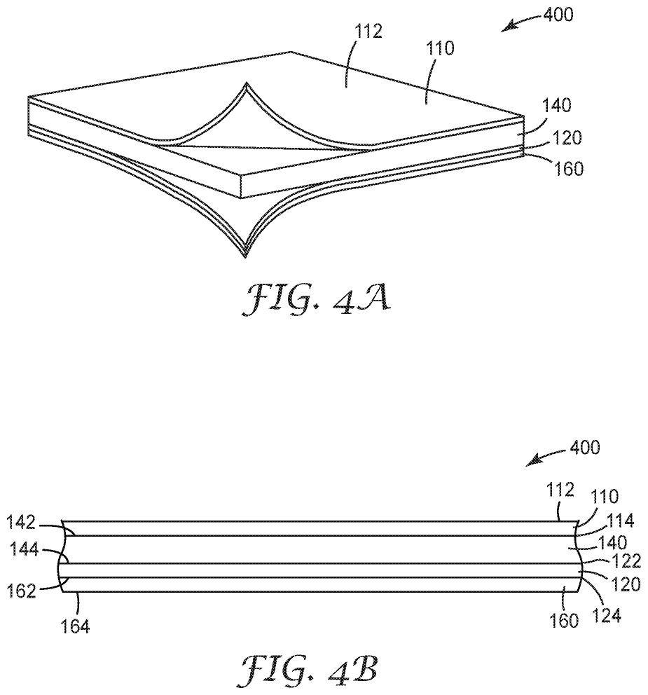

FIGS. 4A and 4B show another embodiment of a packaging material consistent with the teachings herein. The embodiment of FIGS. 4A and 4B is similar to that of FIGS. 1A and 1B except that core portion 140 is not a corrugated material. Instead, core portion 140 is a non-corrugated, generally flat material such as, for example, a layer of foam.

Those of skill in the art will appreciate that many changes may be made to the specific construction shown in FIGS. 4A and 4B. Each portion may include multiple layers or a single layer. Additional layers or portions may be between the portions or layers shown. For example, an adhesive layer (or other attachment layer) may be between core layer 140 and stiffening layer 160 to hold these two portions or layers firmly together.

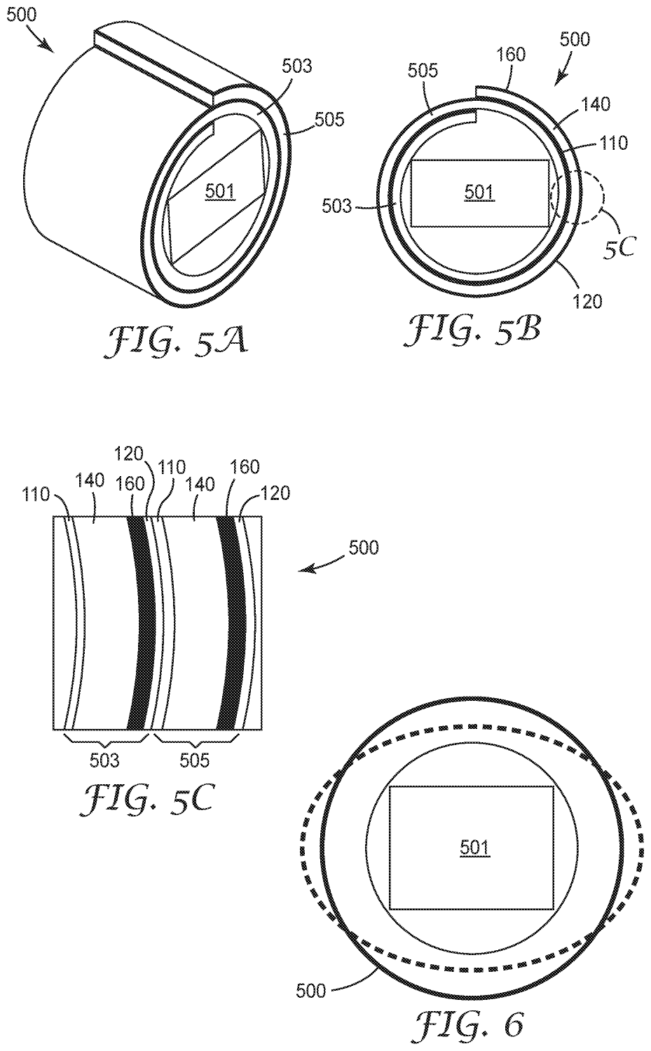

When in use, the packaging materials described herein can be wrapped around an item. In some embodiments, it is preferred that the packaging material be wrapped around the item such that two layers of the packaging material overlap one another. This is shown schematically in FIGS. 5A-5C.

FIGS. 5A and 5B are respective perspective and side views of one of the embodiments of packaging material described herein rolled around an item 501. FIG. 5C shows a side view of a portion of the packaging construction of FIG. 5B. The exemplary packaging material shown in FIGS. 5A-5C is that of FIGS. 4A and 4B. However, any of the packaging materials described herein can be used to form packaging construction 500. Packaging construction 500 includes two layers: a first layer 503 and a second layer 505 of packaging material that are adjacent to one another.

More specifically, packaging construction 500 includes first attachment portion 110 adjacent to core portion 140 adjacent to stiffening portion 160 adjacent to second attachment portion 120 adjacent to first attachment portion 110 adjacent to core portion 140 adjacent to stiffening portion 160 adjacent to second attachment portion 120. For purposes of clarity, each layer can have a single layer or multilayer construction.

When first and second layers 503 and 505 are placed directly adjacent to one another, first and second attachment layers 110 and 120 contact and attach or bond to one another. This attachment or bonding assists in creating the rigidity of packaging construction 500.

As shown in FIG. 6, packaging construction 500 will deflect slightly when a load is placed on it (e.g., force loading caused by stacking packages during transit, etc.). During this deflection, the overall shape of the packaging construction may change slightly (for example, as is shown in FIG. 6, the round shape changes to a more oval shape). In some embodiments, the package construction deflects no more than 7.62 cm, or 6.35 cm, or 5.08 cm, or 3.81 cm, or 2.54 cm. In some embodiments, the package construction deflects between about 0.125 cm and about 7.62 cm. The minimal deflection is due to the enhanced bending stiffness of the packaging construction, which provides crush resistance so that the item wrapped in the packaging construction is safe and undamaged during transit. This crush resistance is created by the layers of the packaging material working in coordination. Each of these four portions works cooperatively to result in a packaging material capable of forming a packaging construction with the unique properties described herein.

First and second attachment portions 110 and 120 each permit packaging material 100 to attach, adhere, or bond to itself once wrapped around an item. First and second attachment portions 110 and 120 thus permit the first and second layers of packaging material to attach or bond to one another. In some embodiments, first and second attachment portions 110 and 120 do not substantially adhere, attach, or bond to the item or other materials.

Core portion 140 provides at least one or more of the following attributes: compressive strength, shear, and spacing while also holding stiffening portion 160 firmly in position. The bending stiffness of packaging construction 500 results from maintaining the relative lateral position and vertical separation of the stiffening layers 160 in adjacent layers 503 and 505 upon deflection caused by force loading (e.g., force loading caused by stacking packages during transit, etc.). Deflection subjects the core layer or portion to compression forces and shear forces (shear forces between adjacent layers of the packaging material). Formation of a packaging material construction that resists these forces enhances overall packaging construction performance.

In some embodiments (e.g., embodiments including a corrugated core portion), stiffening portion 160 holds core portion 140 in position and assists it to maintain its compressive and/or spacing properties. When a packaging construction formed from the packaging material is subjected to a load and deflects, the stiffening portions 160 are subjected to tension and compression respectively. Stiffening layers including a high tensile modulus material resist these stresses and strains and impart bending stiffness to the construction. A stiff packaging construction deflects less under a load and protects the contents from being crushed.

More information about each of the materials, portions, and/or layers of the packaging material and/or packaging construction is provided below.

First and Second Attachment Portions:

The first and second attachment layers or portions can be the same material or construction as one another or can be different materials or constructions than one another.

The first and second attachment layers or portions can be any material or construction that permits these layers to attach, bond, and/or adhere to one another. In some embodiments, the first and second attachment layers or portions have a peel strength (when peeled from one another) of greater than 39.37 gm/cm, or greater than greater than 49.21 gm/cm, or greater than 59.05, or greater than 68.90, or greater than 78.74 gm/cm as measured by the T-peel test of ASTM D1876-08 (2015). This peel strength may be desirable in some embodiments because adjacent layers of the packaging material (FIGS. 5A and 5B: layers 503 and 505) may delaminate when under load. Delamination is a failure mechanism that can result in loss of bending stiffness of the packaging construction and hence inadequate crush protection.

In some embodiments, at least one of the first and second attachment layers or portions has a shear modulus of greater than 0.3 MPa, or greater than 0.4 MPa, or greater than 0.5 MPa as measured by ASTM D1002 when adhered to one another layer of the material of the present disclosure. Typical pressure sensitive adhesives (PSAs) have a sheer modulus of less than 0.1 MPa. The higher shear modulus of cohesive adhesives as compared to PSAs enables a stiffer packaging construction and thus greater crush resistance.

In some embodiments, the bonding timescale for the formation of the bond or attachment between the first and second attachment portions or layers is between about 0.1 second and about 60 seconds, or about 1 second to about 10 seconds. In some embodiments, the bonding timescale is at least about 0.1 second, or about 0.5 second, or about 1 second. In some embodiments, the bonding timescale is less than about 10 seconds, or less than about 7 seconds, or less than about 5 seconds. Some packaging constructions have a longer bonding timescale (the time for a bond to form between the first and second attachment portions). This can permit the user to attach, unattach, and reattach the first and second packaging layers more than once or multiple times without the first and second attachment layers firmly bonding or attaching to one another. This can permit the user to reposition the layers multiple times, which may create a positive user experience. In some embodiments, the user can attach, unattach, and reattach the first and second packaging layers at least 2, or at least 3, or at least 4, or at least 5, or at least 8, or at least 10, or at least 12 times without the first and second attachment layers failing (e.g., not reattaching and/or not forming the necessarily firm bond or attachment between the first and second packaging material layers).

In some embodiments, the shear strength for at least one of the first and second attachment portions or layers of the present disclosure is greater than about 0.034 Mpa, or 0.07 MPa, or 0.10 MPa, or 0.14 MPa, or 0.17 MPa, or 0.21 MPa, or 0.24 MPa, or 0.28 MPa, or 0.31 MPa, or 0.34 MPa, or 0.52 MPa, or 0.07 MPa psi as measured according to ASTM D3163-01.

In some embodiments, at least one of the first and second attachment layers includes at least one of a mechanical attachment mechanism, a cohesive adhesive, a structural adhesive, or a combination thereof. Some embodiments include a mechanically enhanced cohesive adhesive. Some exemplary mechanical attachment mechanisms include a hook and loop construction and/or a Dual Lock™ fastening construction. Some exemplary commercially available structural adhesives include acrylic adhesives such as 3M Scotch-Weld DP8407NS, epoxies such as 3M Scotch-Weld DP110, or Urethane adhesives such as 3M Scotch-Weld DP605NS.

Cohesive Materials

In some embodiments, first and/or second attachment layers or portions include cohesive and/or are cohesive. As used herein, the term “cohesive” means an adhesive that adheres to itself and not substantially to other materials. In some embodiments, the cohesive composition and/or layer is not significantly tacky to the touch at ambient temperatures. In some embodiments, cohesive compositions and/or layers have a tack of less than 30 grams when measured by a TA-XT2i Texture Analyzer according ASTM D-2979. In some embodiments, the tack (when measured as described above) is less than 20 grams, or less than 10 grams. In some embodiments, the cohesive compositions and/or layers have less than about 20 wt % tackifier, plasticizer, and/or mixtures thereof based on the total weight of the cohesive composition. In some embodiments, cohesive compositions and/or layers have less than about 15 wt %, or less than about 10 wt %, or less than about 5 wt % tackifier, plasticizer, and/or mixtures thereof based on the total weight of the cohesive composition.

In some embodiments, the cohesive composition, layer, or material is co-adherent to itself while being able to contact other surfaces without significantly or substantially sticking, damaging, or leaving a residue which would otherwise mar the surface or damage the other surfaces. In some embodiments, the cohesive will remove cleanly from an adjacent article (i.e., without damaging the article) while adhering sufficiently strongly to itself and/or to another cohesive surface so as to create a strong bond that is sufficient to stay adhered or bonded in the desired configuration or orientation during use. In some embodiments, the cohesive composition and/or layer is capable of being cleanly removed from an article to which it has been exposed, meaning that it does not damage and/or leave significant residue on the article when it is removed from the article.

One benefit of a construction including cohesive as or in at least one of the first and second attachment portions or layers is that the first and second attachment layers will not substantially adhere to the item or to other packages not wrapped with the packaging materials described herein.

Cohesive compositions for use in the first and second attachment layer or portion preferably have at least one of high shear modulus, good shear strength, sufficient peel resistance, and/or adequate bonding timescale (the time is takes for a sufficient bond to form between the first attachment portion of the first layer and the second attachment portion of the second layer). These properties are desired because when compressed, the layers in the packaging material/construction are subject to shear and delamination forces. The bond between the first and second attachment layers or portions must resist these forces in order for the structure to have sufficient bending stiffness and thus offer crush protection.

Any cohesive composition and/or layer that meets one or more of the above requirements can be used in the packaging materials and/or constructions of the present. Some exemplary commercially available cohesive compositions that can be used include, for example, Valpac CH 261, 262, and 265.

In some embodiments, the cohesive material or layer includes at least one of natural rubber, synthetic polyisoprene, block copolymer, amorphous poly alpha-olefin, polyurethane, and blends or combinations of the foregoing.

In some embodiments, the cohesive material or layer is a thin layer of plastic material including tackifier sufficient to enable the adhesive to adhere to itself. In some embodiments, the tackifier is homogeneously dispersed in the plastic layer. In some embodiments, the tackifier includes at least one of a rosin ester, hydrocarbon resin, terpene resin, and derivatives or blends of them. One or more plasticizers can also be incorporated into another material such as, for example, a mineral oil.

In some embodiments, the cohesive material or layer includes rubber, thermoplastic elastomer, filler, and UV and/or heat stabilizers. In some embodiments, the cohesive composition in the first attachment layer includes between about 30-90 wt % rubber; 10-70 wt % thermoplastic elastomer; and 10-100 parts filler per 100 parts total rubber+thermoplastic elastomer. Some embodiments also include 0.1-10 parts UV and/or heat stabilizer per 100 parts total rubber+thermoplastic elastomer. More information about such cohesive compositions or materials can be found in, for example, U.S. Patent Application No. 62/717,942, assigned to the present assignee, which is incorporated by reference in its entirety.

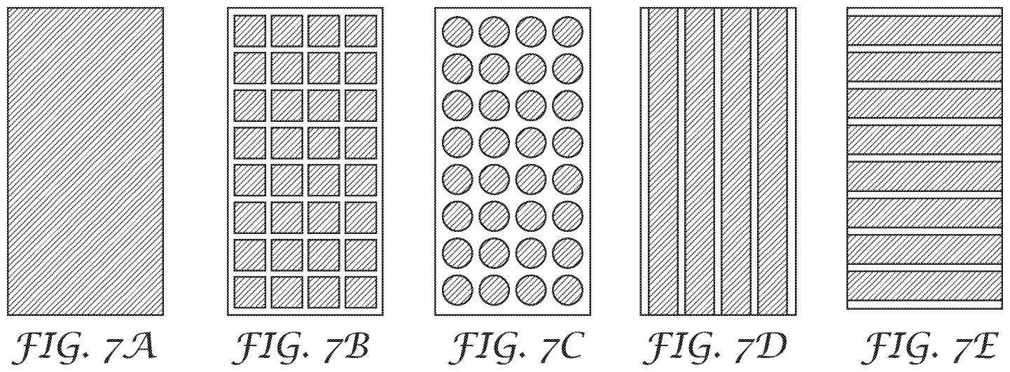

In some embodiments, it may be desirable to coat less than the entire major surface of the core layer with the cohesive composition and/or attachment structure. In instances where a cohesive and/or adhesive is used, a screen type roller or rotary screen printing device can be used to selectively apply the adhesive or cohesive coating upon only specific areas of the core layer. Alternatively, a spray head or series of spray heads may be used to selectively deposit a particular pattern or random spray. The pattern can be arranged to achieve a desired adhesion. Some exemplary patterns are shown schematically in FIGS. 7A-7E.

In some embodiments, the first attachment layer, portion, or material is applied to substantially all (e.g., at least 75% of the total surface area) of one major surface of the core portion. In some embodiments, the first attachment layer, portion, or material is applied to at least 10%, or at least 20%, or at least 30%, or at least 40%, or at least 50%, or at least 60%, or at least 70%, or at least 75%, or at least 80%, or at least 85%, or at least 90%, or at least 95%, or at least 97%, or at least 99% of the total surface area of at least one major surface of the core layer or portion. In some embodiments, the second attachment layer, portion, or material is applied to substantially all (e.g., at least 75% of the total surface area) of one major surface of the stiffening layer or portion. In some embodiments, the second attachment layer, portion, or material is applied to at least 10%, or at least 20%, or at least 30%, or at least 40%, or at least 50%, or at least 60%, or at least 70%, or at least 75%, or at least 80%, or at least 85%, or at least 90%, or at least 95%, or at least 97%, or at least 99% of the total surface area of at least one major surface of the stiffening layer or portion.

In some embodiments that include a patterned or non-continuous adhesive, cohesive, or attachment portion, it may be preferable to have discrete open (uncoated) areas that have a size of less than about 10× or 20× the thickness of a single layer of the packaging material. In some embodiments, the first and/or second attachment portion is applied nominally or substantially uniformly across the length and width of the core and/or stiffening layer. In some embodiments where the adhesive is non-continuous, the gaps in adhesive coverage are between about 0.01 CM and about 2.54 CM. In some embodiments, the gaps in adhesive coverage are greater than about 0.01 cm, or 0.0254 CM, or 0.127 cm, or 0.19 cm, or 0.254 cm. In some embodiments, the gaps in adhesive coverage are less than about 2.54 cm, or 1.27 CM, or 1.016 cm, or 0.762 cm, or 0.508 cm. In some embodiments, one advantage of including a non-continuous adhesive, cohesive, or attachment portion is that the weight of the packaging roll can be reduced. In some embodiments, another advantage of including a non-continuous adhesive, cohesive, or attachment portion is that the degree of attachment can be controlled to fit a desired end use.

In some embodiments, cohesive compositions may be preferred over both pressure sensitive adhesives (PSAs) and structural adhesives for a variety of reasons. As stated above, when compressed, the layers in the packaging material/construction are subject to shear and delamination forces. The first and second attachment layers must resist these forces in order for the structure to have sufficient bending stiffness and thus offer crush protection. As such, the first and second attachment layers preferably have high shear modulus, good shear strength, and/or sufficient peel resistance. Also, a sufficient bond between the first wrap 103 and the second wrap 105 preferably forms rapidly (a short bonding timescale) and without a specialized activation means (which can add to cost and inconvenience). Structural adhesives offer high modulus but can have undesirably long timescale and complicated activation processes. Further, the presence of uncured resin in some structural adhesives may require them to be contained if used in a consumer product. PSAs offer fast bonding, but their shear modulus can be too low for the present applications. PSAs may also undesirably adhere to a wide range of materials including the item in a package. Further, under the load that the packaging construction may be exposed to, packaging constructions incorporating PSAs will likely deform too much to offer sufficient crush protection.

Core Portion

Any core layer of portion may be used that provides the following properties: flat crush resistance and separation. Further, the core layer or portion preferably exhibits good adhesion to the adjacent layers (e.g., first attachment portion 110 and stiffening portion 160).

Some core constructions need to be geometrically constrained to exhibit sufficient flat crush resistance to be effective as core materials. For example, the paper flutes in a corrugated construction, have negligible flat crush resistance on their own. However, when bonded to the stiffening layer, even on one side, in a single face configuration, they develop significant flat crush resistance and act as highly effective core materials. For such core constructions, flat crush values reported are those for the geometrically constrained configuration. Other core materials, e.g. rigid foams, exhibit inherently high flat crush resistance, without needing to be constrained.

In some embodiments, the core layer or material has a flat crush resistance of between about 0.05 MPa and about 10 MPa as measured by Tappi T825. In some embodiments, the core layer or material has a flat crush resistance of at least about 0.1 MPa, or at least 1 MPa, or at least 5 MPa, or at least 10 MPa, or at least 15 MPa as measured by Tappi T825. In some embodiments, the core layer or material has a flat crush resistance of less than about 50 MPa, or less than about 45 MPa, or less than about 40 MPa, or less than about 35 MPa as measured by Tappi T825.

In some embodiments, the core layer or material has a shear modulus of between about 0.3 MPa and about 5 MPa as measured by ASTM C 273. In some embodiments, the core layer or material has a shear modulus of at least about 0.3 MPa, or at least about 0.5 MPa, or at least about 1 MPa, or at least about 2 MPa as measured by ASTM C 273. In some embodiments, the core layer or material has a shear modulus of less than about 5 MPa, or less than about 4.5 MPa, or less than about 4 MPa as measured by ASTM C 273. In some embodiments, the core layer, portion, or material has a spacing or thickness of between about 0.040 cm and about 2.54 cm. In some embodiments, the core layer, portion, or material has a spacing or thickness of between about 0.159 CM and about 1.27 cm. In some embodiments, the core layer, portion, or material has a thickness of greater than 0.040 CM, or greater than 0.079 cm, or greater than 0.16 cm, or greater than 0.3174 cm, or greater than 0.635 CM, or greater than 1.27 cm. In some embodiments, the core layer, material, or portion has a thickness of less than 2.54 cm, or less than 1.9 cm, or less than 1.27 CM, or less than 0.635 cm. In some embodiments, the core material or layer is embossed to create additional height or spacing.

Some exemplary core material(s), portion(s), or layer(s) include paper, film, plastic, polymeric material, molded pulp, non-woven materials, woven materials, foam, and combinations thereof. In some embodiments, the core portion or layer is a monolithic structure. In some embodiments, the core portion or layer is a multilayer construction. In some embodiments, the core material(s), portion(s), or layer(s) include at least one of natural fibers, polymers, inorganic materials, or metals. In some embodiments, the core material(s), portion(s), or layer(s) is/are at least one of lightweight or open structures such as, for example, nets, scrims, or webs. In some embodiments, the core layer can include a mechanical fastener, such as, for example, Dual Lock™ fasteners.

In some embodiments, the core layer includes posts on sheets of material. This can be made, for example, by slitting or removing portions of a foam material. In some embodiments, between about 2% and about 10% of the foam material is removed to form the posts.

In some embodiments, the core material is a corrugated material, such as, for example, corrugated paper or plastic. FIG. 9A shows one exemplary core portion that is a corrugated material. Corrugated core portion 900 of FIG. 9A includes a plurality of flutes 150 extending in flute direction F that each include a ridge 142 and a valley 144.

Corrugated materials offer excellent spacing properties at a reasonable cost with wide availability. Corrugated paper offers the added advantage of being easily recyclable. Any corrugated construction that meets the goals described herein can be used. Any corrugation pattern may be used including, for example, waves (e.g., sine waves), random corrugation, 2-dimensional corrugation, and combinations thereof.

In some embodiments, the corrugated material has a flute spacing of between about 66 flutes/m and about 591 flutes/m. In some embodiments, the corrugated material has a flute (or ridge) height of between about 0.16 cm and about 0.635 cm (which is the full flute height from the valley to the ridge). In some embodiments, the corrugated material has a flute pitch of between about 0.85 cm and about 0.18 cm.

In some embodiments, the core portion includes a single corrugated material where the corrugation is the same or consistent across or along the entire core portion. In some embodiments, it may be desirable to vary the fluting or corrugation pattern across the core portion. This is because a possible failure mode of standard corrugated fiberboard, with standard flutes, upon bending, is collapse or buckling of the stiffening layer into the furrows. This collapse or buckling reduces the spacing between the opposing liners (stiffening) layers. As a result, the corrugated material loses its bending stiffness. To minimize the incidence of potential collapse or buckling, the flute pattern may be varied to break up the continuity of the furrows. That way, even if buckling or collapse occurs, it is localized, and its impact is thus minimized.

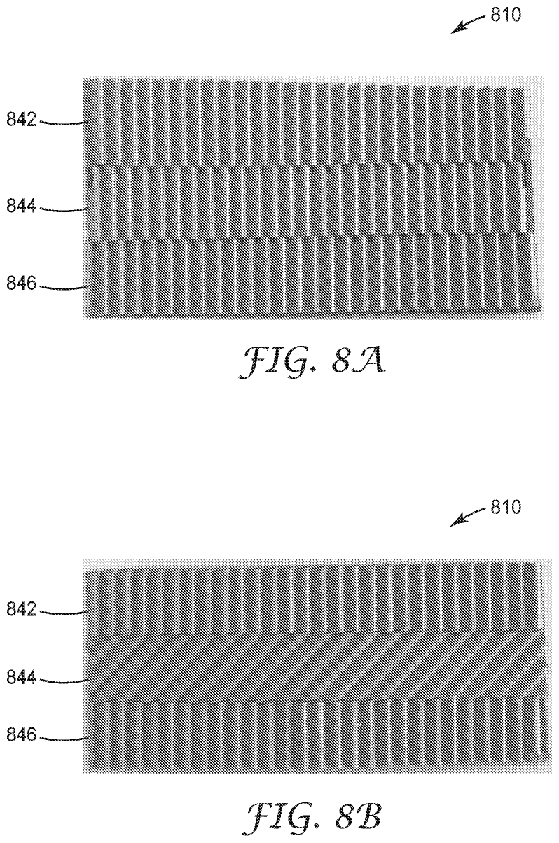

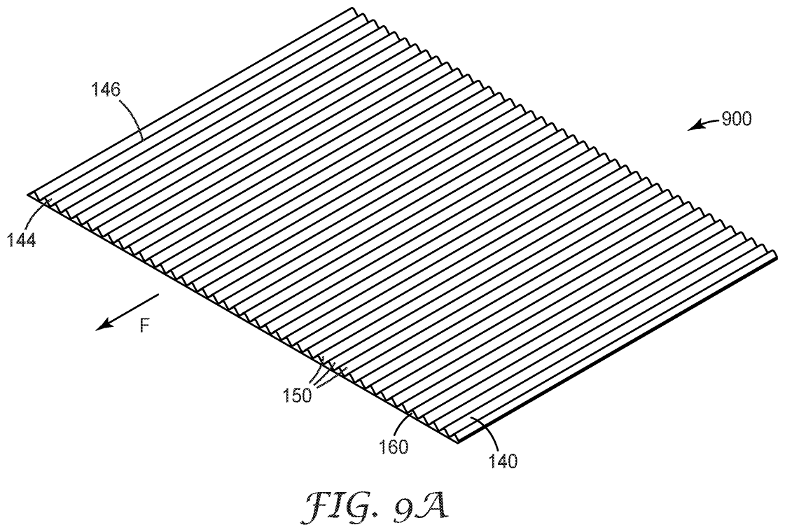

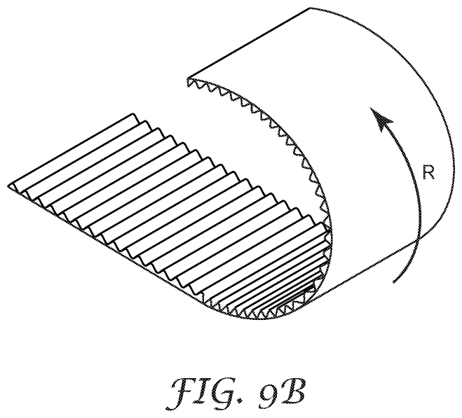

Two exemplary constructions having varied corrugation are shown in FIGS. 8A and 8B, which depict two embodiments of packaging material 810. In FIG. 8A, the core layer or portion 840 includes a first strip portion 842, a second strip portion 844, and a third strip portion 846. Each strip portion has a corrugated construction that includes a plurality of flutes each having a ridge and a valley. In each strip portion, the flutes all run in the same direction. However, the ridges of the flutes in first strip portion 842 are out of phase with the ridges of the flutes in second strip portion 844 which are out of phase with the ridges of the flutes in third strip portion 846. Specifically, the ridges of the flutes in first strip portion 842 are aligned with the valleys of the flutes in second strip portion 844. Further, the ridges of the flutes in second strip portion 844 are aligned with the valleys of the flutes in third strip portion 846. Those of skill in the art will recognize that many changes may be made to this construction while still achieving these advantages. For example, more than three strips can be used and/or the flute alignment may vary. Additionally, other flute patterns can be used.

In FIG. 8B, core layer or portion 840 includes a first strip portion 842, a second strip portion 844, and a third strip portion 846. Each strip portion has a corrugated construction that includes a plurality of flutes each having a ridge and a valley. First and second strip portions 842 and 846 have substantially identical or similar flute constructions. Second strip portion has a flute construction that is at an approximately 45° angle from the flute construction of first and second strip portions 842 and 846. Those of skill in the art will recognize that many changes may be made to this construction while still achieving these advantages. For example, more than three strips can be used. Further, the angle of flute construction need not be 45° but can be any angle between 10 degrees and 170 degrees. Further, each strip can have a different angled flute construction and/or more than two different flute construction angles can be used. Additionally, other flute patterns can be used.

Where strips of this type are used, the width of the strips can be any desired width that achieves the goals described herein. For example, the width of the strips may be 0.635 cm or greater. In some embodiments, there is a gap between adjacent strips. In some embodiments, the gap is between about 0/08 and about 1.27 cm. In other embodiments, there is no gap between the strips.

Stiffening Portion:

The stiffening layer or layer layers of the present disclosure can be any materials or layers that have high tensile modulus and/or high tensile strength. In some embodiments, the stiffening layer or portion or material has a tensile modulus of at least about 100 MPa, or at least about 125 MPa, or at least about 150 MPa, or at least about 175 MPa, or at least about 200 MPa as measured by ASTM D828-16. In some embodiments, the stiffening layer or portion or material has a tensile strength of at least 0.1 MPa, or at least about 0.5 MPa, or at least about 1 MPa, or at least about 2 MPa, or at least about 3 MPa, or at least about 4 MPa, or at least about 5 MPa as measured by ASTM D828-16.

Some exemplary stiffening layers, portions, or materials include films, non-wovens, wovens, nets, meshes, or scrims. In some embodiments, the stiffening layer or stiffening layer includes one or more of natural fibers (e.g., paper), polymers, inorganic materials (e.g., fiberglass), or metals (e.g., metal foil). In some embodiments, paper is a preferred option because it offers high tensile modulus and strength, is recyclable, and is widely available at low cost. In some embodiments, the stiffening layer or portion is a single layer. In some embodiments, the stiffening layer or portion is a multilayer or multicomponent material or structure.

In some embodiments, the stiffening portion or layer has a thickness of between about 0.006 mm and about 0.762 mm. In some embodiments, the stiffening portion or layer has a thickness of greater than 0.006 mm, or 0.0127 mm, or 0.019 mm, or 0.0254 mm, or 0.762 mm, or 0.127 mm, or 0.19 mm, or 0.254 mm. In some embodiments, the stiffening layer or portion has a thickness of less than 0.762 mm, or 0.635 mm, or 0.508 mm, or 0.381 mm.

Structural Assembly

The combined stiffening layer/core layer construction is referred to as the structural assembly. Many of the properties mentioned above with respect to the core layer or portion and the stiffening layer or portion are important for the structural assembly. Such properties include, for example, the flexibility, tensile modulus, spacing, tensile strength, and/or shear modulus. In some embodiments, one or more of these properties of either the core layer or portion and/or the stiffening layer or portion can fall outside of the desired ranges provided herein as long as the structural assembly as a whole has one or more of the following properties. This is because these two layers work cooperatively to provide all of these properties or features. As one of these properties increases or decreases, it affects the others.

In some embodiments, the structural assembly has a tensile modulus of at least about 100 MPa, or at least about 125 MPa, or at least about 150 MPa, or at least about 175 MPa, or at least about 200 MPa as measured by ASTM D828-16. In some embodiments, the structural assembly has a tensile strength of at least 0.3 MPa, or at least about 0.5 MPa, or at least about 1 MPa, or at least about 2 MPa, or at least about 3 MPa, or at least about 4 MPa, or at least about 5 MPa as measured by ASTM D828-16

In some embodiments, the structural assembly has a shear modulus of between about 0.3 MPa and about 5 MPa as measured by ASTM C 273. In some embodiments, the structural assembly has a shear modulus of at least about 0.3 MPa, or at least about 0.5 MPa, or at least about 1 MPa, or at least about 2 MPa as measured by ASTM C 273. In some embodiments, the structural assembly has a shear modulus of less than about 5 MPa, or less than about 4.5 MPa, or less than about 4 MPa as measured by ASTM C 273.

In some embodiments, the structural assembly has a flat crush resistance of between about 0.05 MPa and about 10 MPa as measured by Tappi T825. In some embodiments, the structural assembly has a flat crush resistance of at least about 0.1 MPa, or at least 1 MPa, or at least 5 MPa, or at least 10 MPa, or at least 15 MPa as measured by ASTM Tappi T825. In some embodiments, the structural assembly has a flat crush resistance of less than about 50 MPa, or less than about 45 MPa, or less than about 40 MPa, or less than about 35 MPa as measured by Tappi T825.

In some embodiments, the structural assembly has a spacing or thickness of between about 0.04 cm inch and about 2.54 cm. In some embodiments, the structural assembly has a spacing or thickness of between about 0.16 cm and about 1.27 cm. In some embodiments, the structural assembly has a thickness of greater than 0.04 CM, or greater than 0.08 cm, or greater than 0.16 CM, or greater than 0.32 cm, or greater than 0.635 cm, or greater than 1.27 cm. In some embodiments, the structural assembly has a thickness of less than 2.54 cm, or less than 1.9 cm, or less than 1.27 cm, or less than 0.635 cm. In some embodiments, the structural assembly is embossed to create additional height or spacing.

In some embodiments, the stiffening layer is attached, adhered, or bonded to the core layer to form the structural assembly. In some embodiments, the attachment or bonding occurs by way of adhesive or mechanical means. In some embodiments, the core portion and stiffening portion are bonded or adhered together by, for example, being fused, glued, or by coextrusion. In some embodiments, the core portion and stiffening portion are formed of the same material such that the core portion and stiffening portion are a monolithic or single material structural assembly. In some embodiments, the core portion and stiffening portion are made of the same material. In some embodiments, the core portion and stiffening portion are formed of differing materials.

Optional Flap Portion(s)

Some embodiments of the packaging materials and constructions of the present disclosure include one or more flap portions that provide a layer adjacent to the first or second attachments layers when the packaging material is rolled. Such a layer can, for example, prevent the first or second attachment layer of a first layer of material from contacting/adhering to the first or second attachment layer of the second layer of material that rolls over and contacts the first layer of packaging material in embodiments where the packaging material is manufactured or stored in a roll form.

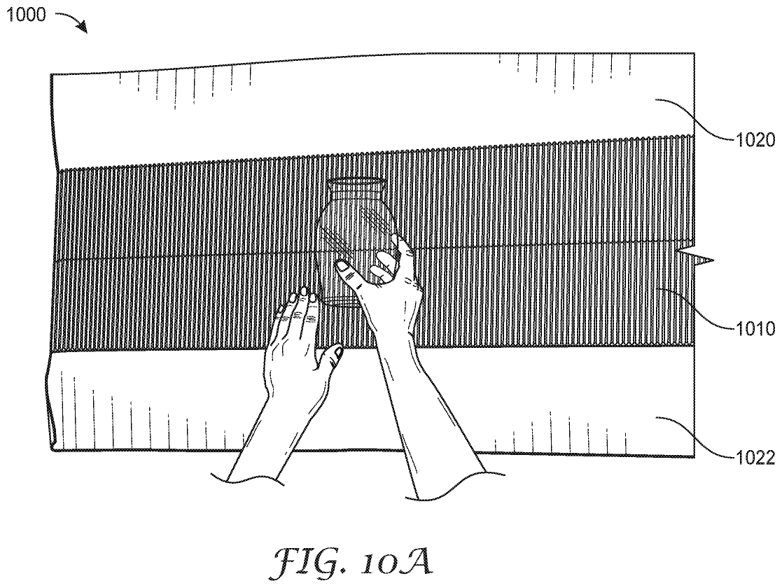

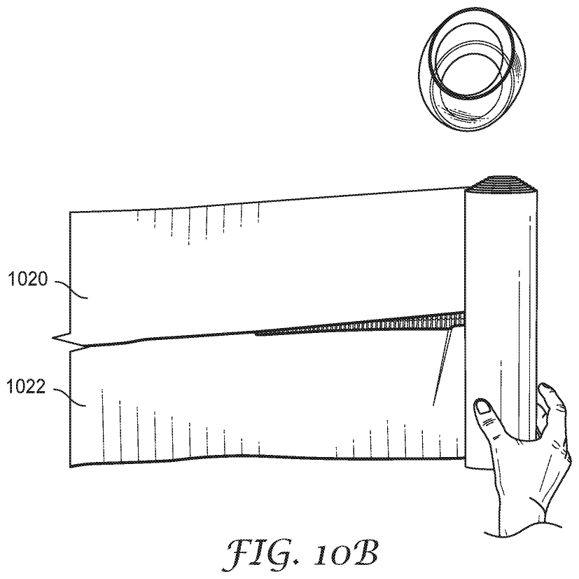

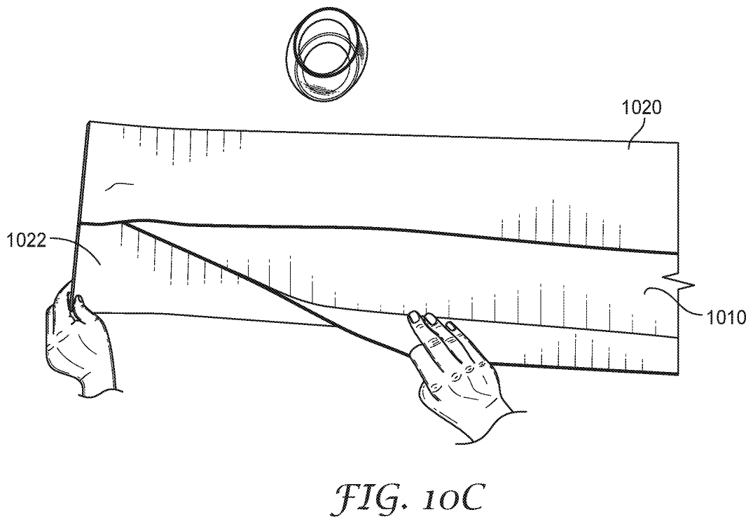

One exemplary embodiment of a packaging material 1000 including two flaps is shown in FIGS. 10A-10C, which are all top views of packaging material 1000. Packaging material 1000 includes a crush-resistant portion 1010 (including the structural assembly and first and second attachment portions) and two flaps 1020 and 1022 that are each attached to the first and second (or upper and lower, respectively) ends of the crush-resistant portion 1010. In this specific implementation, flaps 1020 and 1022 are attached to crush-resistant portion 1010 on the bottom (not shown) side of packaging material 1000. In the specific implementation of FIGS. 10A-10C, each flap is adhered to crush-resistant portion 1010 using an adhesive but any known attachment method may be used including, for example, lamination, bonding, mechanical attachment, etc. may be used.

As shown in FIG. 10B, flaps 1020 and 1022 can be folded over crush-resistant portion 1010 during manufacturing so that a user who purchases the roll of packaging material receives the roll in form shown in FIG. 10B. As shown in FIG. 10B, the flaps separate the first and second attachment portions of the adjacent layers of packaging material and thus eliminate any possibility of the first and second attachment portions sticking or adhering to one another during manufacturing, shipping, or storage in a retailer or user location. When the user desires to use packaging material 1000, the user easily lifts flaps 1020 and 1022 off of (or separates flaps 1020 and 1022 from) crush-resistant portion 1010. More information on wrapping an item with a packaging material including flaps will be described later in the disclosure.

Those of skill in the art will appreciate that many changes may be made to this construction while still falling with the scope of the present disclosure. For example, the implementation shown in FIGS. 10A-10C includes two flaps. However, the packaging construction may include a single flap or more than two flaps. The flaps may be segments or disconnected from one another along their length. The flaps can be in any desired shape or size.

The one or more flaps can be made of any material capable of effectively separating the first and second attachment portions and being attached to the crush-resistant portion. Some exemplary flap materials include paper, plastic, a nonwoven material, a scrim, a mesh material, and the like. In some embodiments, one or more of the flaps are made of the same material as the stiffening layer. In some embodiments, the flaps are formed by and are the stiffening layer that has been extended past the core portion and that has not been coated with at least one of the first and second attachment portions. In embodiments including two or more flaps, the flaps may be of the same of differing material from each other.

In some embodiments, the one or more flaps overlap with the crush-resistant portion by between about 0.254 cm to about 12.7 cm or about 1.27 cm to about 7.62 cm, or about 1.9 cm to about 5.08 cm. In some embodiments, the one or more flaps overlap with the crush-resistant portion by at least about 0.254 cm, or about 0.635 cm, or about 1.27 cm, or about 1.905 cm, or about 2.54 cm. In some embodiments, the one or more flaps overlap with the crush-resistant portion by less than about 12.7 cm, or 10.16 cm, or 7.63 cm, or 5.08 cm, or 2.54 cm.

In some embodiments, the one or more flaps overlap with the crush-resistant portion by between about 0.25% to about 20%, or about 0.5% to about 10%, or about 1% to about 5% of the overall surface area of the major surface of the crush-resistant portion to which the flap(s) are attached. In some embodiments, the one or more flaps overlap with the crush-resistant portion by at least about 0.25%, or about 0.5%, or about 1%, or about 2%, or about 3%, or about 4%, or about 5%. In some embodiments, the one or more flaps overlap with the crush-resistant portion by less than about 20%, or about 15%, or about 12%, or about 10%, or about 9%, or about 8%, or about 7% or about 6%, or about 5%.

Optional Separator Layer or Portion:

Some embodiments of the packaging materials and constructions of the present disclosure include one or more separator layers. The separator layer enables unrolling or separating individual sheets depending on whether the packaging wrap is in roll or sheet format. Where present, the one or more separator layers are on or adjacent to one or both of the first and second attachment layers or portions. Exemplary separator layers include coated or uncoated plastic films or paper. The separator layer(s) may be uncoated, have a release coating, and/or have a coating that has some level of adhesion to the cohesive layer. In some embodiments, the adhesion enables secure attachment to the underlying attachment layer as, for example, an outer layer or label, while permitting the separator layer to be peeled off with relative ease when unrolling the packaging material. In some embodiments, the separator layer(s) is a release layer. Some exemplary commercially available separator layers or materials include, for example, Lopasil™ from Loparex Corporation of Cary, N.C. In some embodiments, the separator layer is an outer layer (described below).

Optional Outer Layer or Portion:

Some embodiments include an optional outer layer positioned adjacent to at least one of first and second first attachment layers and/or the optional cushioning layer described herein. Where present, the optional outer layer can be any desired outer layer that provides at least one of the following features: it may be used to passivate the outermost exposed attachment layer of the package, which prevents two packages using this packaging material from adhering or attachment to one another. In some embodiments, the separator layer described above can act as the outer layer.

In some embodiments, at least a portion (and preferably substantially all of the packaging material) is printable so that, for example, logos, messages, advertisements, emblems, trademarks or simply, addressee information etc., may be printed on the exterior or interior surfaces of the formed package with, for example, conventional writing instruments such as pens, pencils, and/or markers. In some embodiments, the outer layer is at least one of water-resistant, waterproof, and/or water impermeable. In some embodiments, the outer layer is at least one of tear-resistant and/or scuff resistant. In some embodiments, the outer layer is non-tacky (meaning not substantially tacky to the touch).

In some embodiments, the outer layer is a single layer. In some embodiments, the outer layer includes multiple layers. As is described in greater detail below, in some embodiments, the outer layer is at least one of single-ply, double-ply, or triple-ply.

In embodiments where the outer layer is single ply, the outer layer material may be a heavy weight paper (such as, for example, kraft paper or the like), a plastic film (such as, for example, MYLAR™), a nonwoven material (such as, for example, TYVEK™), a knit material, or a treated paper (such as, for example, aluminized paper).

In some embodiments, the outer layer includes a paper layer, which can be coated paper, Kraft paper, or higher quality paper such as Bond or white paper. In some embodiments, the paper may be printable and/or metallized to obtain a decorative packaging material. In some embodiments, the metallized paper layer may also be provided with graphics thereon.

In some embodiments, the outer layer includes a plastic. In some embodiments, the plastic is embossed, structured, or reinforced. In some embodiments, the plastic includes at least one of polypropylene, polyethylene, polyurethane, polyester, and/or a copolymer of any of these. In some embodiments, the polyethylene is at least one of a linear low density polyethylene, a low density polyethylene and/or a high density polyethylene. In some embodiments, the plastic is a thermoplastic and/or olefin material. The plastic may be oriented or biaxially oriented to impart high-strength thereto. A biaxial orientation may be preferred for greatest strength. One or more of the surfaces of the plastic layer may be corona discharge treated to render one or more of them receptive to inks and printing. Further, if a decorative package is desired, the plastic may be metallized as by vacuum deposition.

In some embodiments, the outer layer is a two-ply laminate. In some embodiments, the two-ply laminate is a paper/plastic laminate. In some such embodiments, a paper layer is laminated to a plastic film layer. Another exemplary two-ply outer layer is a laminate that includes a water impermeable plastic film having a first corona discharge treated surface that is adhesively cold laminated to a first paper layer. In some embodiments, the two-ply construction (or a portion thereof) is corona discharge treated. This treatment may be applied to the plastic immediately before the first corona discharge treated surface is adhesively laminated to the paper layer. This enables a strong bond to be achieved between the plastic and paper to form a paper-plastic film laminate having first and second opposed outer surfaces.

In some embodiments, the outer layer is three-ply. In some embodiments, the two-ply material(s) described above may further include an additional paper layer to form a paper-plastic-paper, three-ply laminate sheeting. The extra paper layer may be desirable for packaging objects with pointed edges or simply when a packaging material with more strength is desired. As the paper layers form the inner and outer sides of the packaging material, they can easily be printed with graphics or other indicia prior to application of the cushioning and/or cohesive material(s). This enables the packaging material to have one appearance on the outside of the package and another, different appearance on the side of the material that faces the item. When a three-ply paper/plastic/paper laminate is used, the outermost portion of the outer layer can easily be printed using any one of a variety of well-known techniques, including silk screening and the like. The innermost portion of the outer layer (e.g., the plastic film) provides moisture resistance to the article or item that is wrapped by the packaging material. Another exemplary outer layer is a three-ply laminate that includes a water impermeable plastic film having first and second corona discharge treated surfaces that are adhesively cold laminated to first and second paper layers. In some embodiments, the outer layer is more than three layers. In some three-ply embodiments, the outer layer may include a second corona discharge treated surface to render it receptive to inks so that it may exhibit graphics.

In some embodiments, the outer layer is not inherently receptive to printed information, in which case it may be treated to be receptive or a print-receptive skin layer may be used. For example, a plastic film of polyethylene that has the outer surface treated by a corona discharge can then be printed or provided with printed indicia. It is also possible, although less preferred, that the indicia be applied to the packaging material by an adhesive-backed sticker, label or the like.

In some embodiments, the outer layer has a thickness of greater than about 0.0127 mm. In some embodiments where the outer layer is paper, the outer layer has a thickness of greater than about 0.0762 mm.

In addition, if desired a decorative package is provided in an embodiment wherein the exterior surface of the packaging material is metallized or aluminized. If a silver finish is desired, an aluminized surface is preferred. Other metallizing treatments, e.g., with copper, iron, or alloys, can be used when other colors are desired.

In some embodiments, the outer layer is sufficiently tear and scuff resistant such that a wrapped article remains secure and protected during shipping and handling.

In some embodiments, the outer layer includes one or more materials providing at least one of insulation from thermal or acoustic shock and/or radiation protection.

Optional Cushioning Laver:

In some embodiments, the packaging material provides enhanced shock and/or impact resistance to prevent damage of the article or item. This can be achieved, for example, by incorporation of an optional cushioning layer in the packaging material or construction. In some embodiments, the optional cushioning layer is adjacent to either or both of first and second attachment layers. In some embodiments, the optional cushioning layer is adjacent to the core layer such that the cushioning layer is between the core layer and one (or both) of first and second first attachment layers. In some embodiments, the optional cushioning layer is adjacent to the core layer such that the cushioning layer is between the core layer and stiffening layer. The cushioning layer can be any desired layer that provides additional cushioning to the item wrapped in the packaging material or construction described herein. In some embodiments, the cushioning layer can also provide one or more of structural integrity, shock absorption capability, flexibility, and/or interfacial function with other components of the shipper, etc. In some embodiments, it is desired that the cushioning layer have a relatively low profile to avoid excess shipping costs and/or undesirable bulk which would make packaging more complicated and/or storage more challenging.

In some embodiments, the cushioning layer is a single layer. In some embodiments, the cushioning layer includes multiple layers. In some embodiments, the cushioning layer is selected from materials that deform or crush to reduce resultant levels of shock and vibration upon enclosed articles, preferably below critical thresholds for damage for the articles. Illustrative examples of materials suitable for use in cushion members herein include such materials as foams layers (including expanded foams), bubble films or wraps, and structured polymers (e.g., honeycomb structures).

In some embodiments, the cushioning layer includes bubble wrap or bubble film. As used herein, the term “bubble film” is meant to include all pliable, plastic materials including spaced, protruding air-filled bubbles that are capable of providing cushioning. The term is meant to include those items referred to as bubble wrap, bubble pack, bubble paper, air bubble packing, bubble wrapping, and aeroplast. Some embodiments of a bubble films include a first thin flexible layer of plastic material having a plurality of spaced apart recesses in one surface and at least a second thin flexible layer of plastic material bonded to the one surface of the first layer to seal air into the recesses. The bubble film can include, for example, polyethylene as the plastic material for example, a linear low density polyethylene, a low density polyethylene and/or a high density polyethylene. However, other suitable plastics may also be used, such as, for example, polypropylene. Some commercially available bubble films include, for example, Scotch™ Cushion Wrap. The bubble film described in U.S. Patent Application No. 62/620,782, assigned to the present assignee can also be used, and this application is incorporated herein in its entirety.

In some embodiments, the cushioning layer includes foam. Exemplary foams can include, for example, polyethylene, polyester, acrylic, polyurethane, polypropylene, and/or styrene. In some embodiments, the foam is structured.

In some embodiments, the item is wrapped with the cushioning material before it is wrapped with the packaging material, and the packaging material itself does not include a cushioning layer or portion.

Methods of Using the Packaging Material/Forming the Packaging Construction Use of the packaging materials described herein is simple and intuitive. itemitemitemitemitem itemitem

It may be preferable in some embodiments that the user rolls the packaging material in a direction generally perpendicular to the flutes in the corrugated core portion. As shown in FIG. 9B, during rolling, packaging material 900 is rolled such that the direction of roll (R) is generally perpendicular to the direction of the flutes (F) in the corrugated core portion 140. Furrows in flutes 150 make packaging material 900 easy to bend and roll in this direction. If the user attempted to roll packaging material 900 in a direction parallel to flutes 150, packaging material 900 would not have the same flexibility or ease of rolling.

In some embodiments, the packaging material can be rolled parallel to the flute direction (F) as well as perpendicular to the flute direction (F). Packaging materials that can be rolled both directions provide several benefits including, for example, ease of use and/or the option for the user to roll the item in layers that have differing flute directions and which thus offer enhanced crush resistance compared to packaging constructions where the packaging material is wrapped such that the flutes all run in the same flute direction.

One exemplary embodiment of a packaging material that can be rolled parallel to the flute direction (F) as well as perpendicular to the flute direction (F) is shown in FIG. 11. Packaging material 1300 of FIG. 1lincludes a core portion 140 that is corrugated to include a plurality of flutes 150 each of which has a ridge 142 and a valley 144. Flutes 150 run in flute direction (F), which is crossweb in the exemplary embodiment of FIG. 11. One or more gaps or spaces or channels 1356 separate core portion 140 into two or more segments. In this exemplary embodiment, gaps, channels, or spaces 1356 run in the downweb direction, but those of skill in the art will appreciate that gaps 1356 may run in the crossweb direction and flutes 150 may run in the downweb direction. In this embodiment, core portion 140 includes three segments: first segment 1354A, second segment 1354B, and third segment 1354C, each of which are separated or spaced by a gap, channel, or space 1356. Gap, channel, or space 1356 can separate segments 1354 or separate only a portion of segments 1354. In some embodiments, gap, channel, or space 1356 is a gap or space in core portion 140; stiffening portion 160 remains substantially intact such that it does not have significant gaps or spaces. Stiffening portion 160 thus holds segments 954 in position relative to one another because stiffening portion 160 does not have significant gaps, channels, or spaces. Gaps, channels, or spaces 1356 allow the user to roll packaging material 1300 in a direction parallel to the flute direction (F) because they provide a natural bend point to permit packaging material 1300 to bend around an item.

In some embodiments, the generally intact stiffening portion 160 between the gaps, channels, or spaces 1356 includes one or more perforations. Such embodiments enable hand-tearability or easy tear features that may be desirable to the user.

Packaging materials of the present disclosure can include any desired number of segments and/or segment size and/or spacing. In some embodiments, the segment size and/or spacing is uniform or consistent across a portion of the packaging material. In some embodiments, the segment size/shape is variable across a portion of the packaging material. Some embodiments of packaging material include between about 157 segments/m and about 3.3 segments/m or between 131 segments/m and about 16.4 segment/ft, or between about 115 segments/m and about 33 segment/m, or between about 98 segments/m and about 49 segment/m. In some embodiments, the packaging material includes at least about 1 segment/ft, or about 16 segments/m, or about 33 segments/m, or about 49 segments/m. In some embodiments, the packaging material includes less than about 157 segment/m, or about 131 segments/m, or about 115 segments/m, or about 98 segments/m.

Some embodiments include segments having a length (for example, the length dimension shown in FIG. 11) of between about 6.35 cm and about 30.48 cm or about 2.54 cm and about 25.4 cm, or about 7.62 cm to about 20.32. Some embodiments include segments having a length of at least about 0.25 inch, or at least about 2.54 cm, or at least about 7.62 cm. Some embodiments include segments having a length of less than about 30.48 cm, or at least about 25.4 cm, or at least about 20.32 cm.

In some embodiments, the width of the segments, for example, width W as shown in FIG. 11? runs the entire width of the packaging material. However, in other embodiments, the width of the segments is less than the entire width of the packaging material.

Gaps or spaces in the core portion can have any desired forms, size, shape and/or spacing as long as they increase the flexibility and/or rollability of the packaging material in the direction perpendicular to the direction of the flutes in embodiments having a corrugated core portion. The gaps or spaces can be formed in various ways including, for example, material removal, slicing (no to minimal material removal; just a slit cut into the core portion), material compression, scoring, perforation, creasing, and combinations thereof. In some embodiments, the packaging material includes some spaces or gaps formed by one method and other segments or gaps formed by one or more other methods. For example, some embodiments of packaging material include some slits (no to minimal material removal) and some gaps or spaces (material removal or compression).

Where creasing is used, the crease may be formed using a creasing wheel (e.g. Dienes item #021301, diameter 7.62 cm, bore 2.2 cm, thickness 0.62 cm, and with a creasing radius of 0.12 cm). In some embodiments, an array of such creasing wheels may be mounted in the web path of any suitable equipment with an unwind and rewind (e.g. REM Mfg., Model 3250-5T). In some embodiments, the wheels may be spaced apart based on the required segment spacing. In some embodiments, the wheels may be engaged against the corrugated flutes using air pressure. In some embodiments, the depth of the crease may be adjusted from partial to full by varying the air pressure. In some embodiments, the crease depth of is between about 0.106 cm and about 1.27 cm. In some embodiments, the crease depth is approximately 0.32 cm.

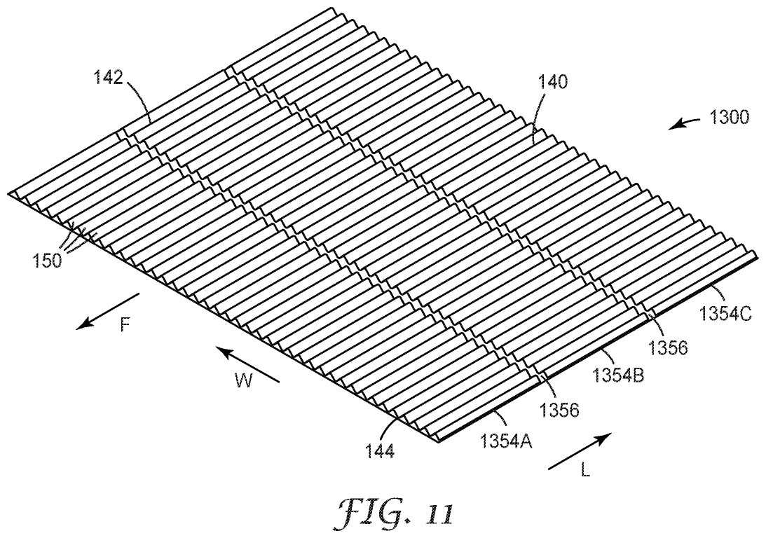

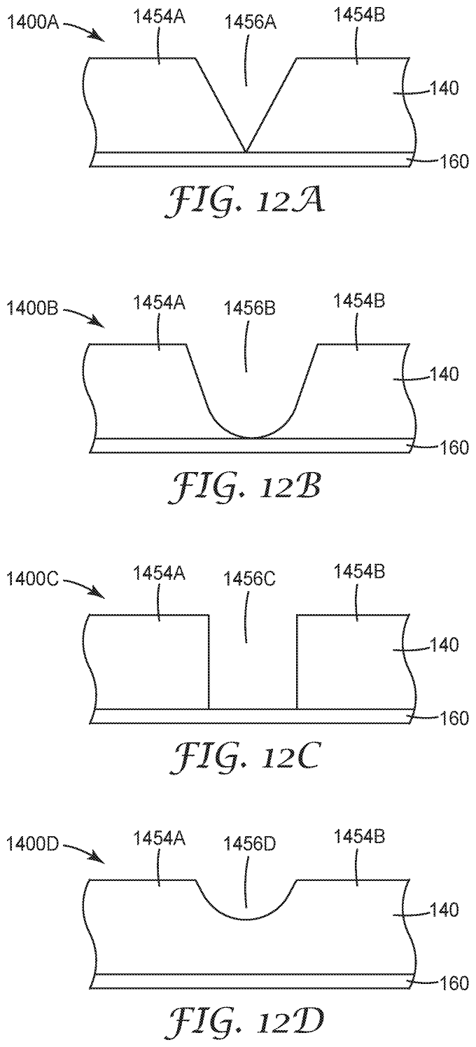

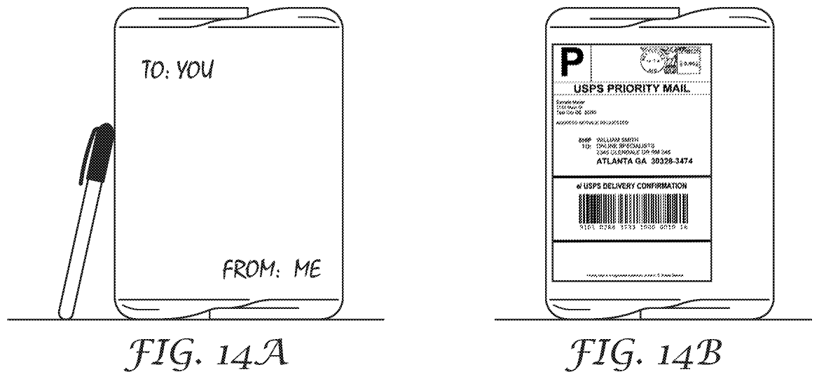

Some exemplary gap or space shapes are shown in FIGS. 12A, 12B, 142, and 14D, which are all cross-sectional views of an exemplary packaging material taken along the length of packaging sheeting 1400 along its length (L) (the direction of packaging material 1400 perpendicular to the length of the gaps or spaces).

The embodiment of packaging material 1400A of FIG. 12A includes a generally v-shaped gap 1456A in core portion 140. Stiffening layer 160 remains intact. V-shaped gap 1456A can be formed by, for example, removing material along the length of gap 1456A using a generally v-shaped tool or by compressing the material in core portion 140 until this gap shape is achieved.

The embodiment of packaging material 1400B of FIG. 12B includes a generally u-shaped gap 1456B in core portion 140. Stiffening layer 160 remains intact. U-shaped gap 1456B can be formed by, for example, removing material along the length of gap 1456B using a generally u-shaped tool or by compressing the material in core portion 140 until this gap shape is achieved.

The embodiment of packaging material 1400C of FIG. 12C includes a generally rectangular space or gap 1456C in core portion 140. Stiffening layer 160 remains intact. Generally rectangular shaped gap 1456C can be formed by, for example, removing material along the length of gap 1456C using a generally rectangular shaped tool.

In some embodiments, core portion 140 material need not be removed or compressed down to stiffening layer 160. In these embodiments, the gap or space need only separate a portion of two adjacent segments 1454 of core portion 140. In some such embodiments, the gap or space can be more of a divot or depression in shape and/or size. One such exemplary embodiment is shown in FIG. 12D. The embodiment of packaging material 1400D of FIG. 12D includes a generally u-shaped space or gap 1456D in core portion 140 that does not extend all the way down to stiffening layer 160. Stiffening layer 160 remains intact. Generally u-shaped gap 1456D can be formed by, for example, removing material along the length of gap 1456D using a generally u-shaped tool or by compressing the material in core portion 140 until the desired gap shape is achieved.

In some embodiments, the gaps or spaces extend 100% of the distance from the top of the core portion (or, where the core portion is corrugated, the ridge) to the stiffening portion. In some embodiments, the gaps or spaces extend 95%, or 90%, or 85%, or 80%, or 75%, or 70%, or 65%, or 60%, or 55%, or 50%, or 45%, or 40%, or 35%, or 30%, or 25% of the distance from the top of the core portion (or, where the core portion is corrugated, the ridge) to the stiffening portion.

In some embodiments, the presence of the segments and/or gaps or spaces facilitates cutting of the packaging material to size. The width of the gap permits easy use of cutting implements such as scissors, blades, or knives because cutting through the stiffening layer and attachment layers versus the entire packaging material (including the core portion) may be easier for the user.

As stated above, packaging material embodiments that can be rolled parallel to the flute direction (F) as well as perpendicular to the flute direction (F) offer various advantages and/or benefits. In addition to other advantages mentioned herein, the user can roll the item in packaging material layers that have differing flute directions. This can offer enhanced crush resistance compared to packaging constructions where the packaging material is wrapped such that the flutes all run in the same flute direction.

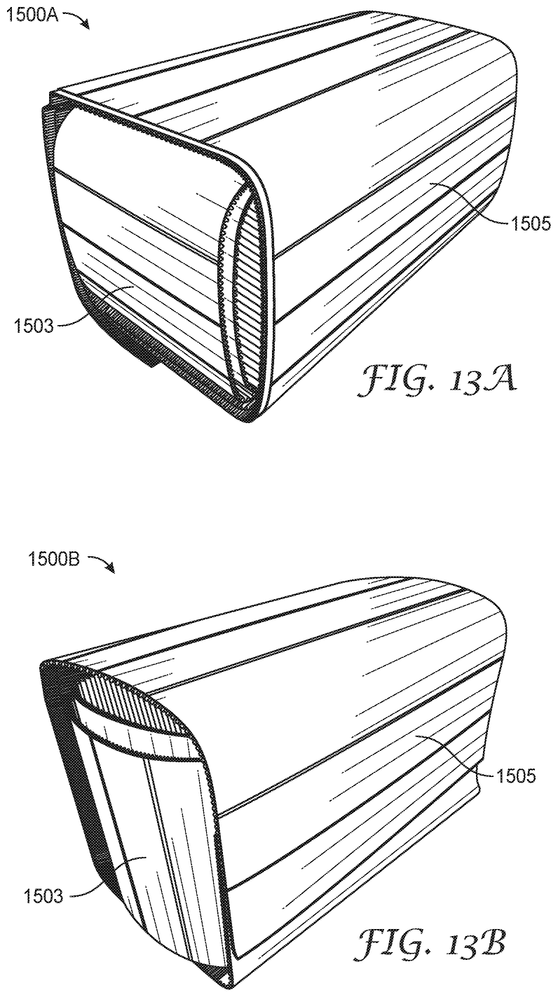

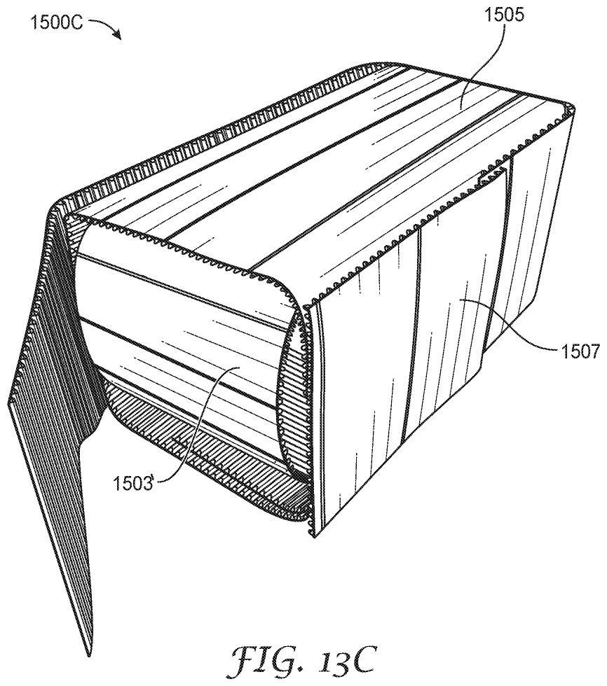

FIGS. 13A, 13B, and 13C are photographs depicting three different packaging constructions/methods of use. All three packaging constructions of FIGS. 13A, 13B, and 13C include three layers of packaging material of the type generally described herein wrapped around an item. The sole difference in the three embodiments is the flute direction in the layers. In all three photographs, flute direction is indicated by the black line on the packaging construction.

Packaging construction 1500A of FIG. 13A includes a first wrap 1503 and a second wrap 1505. First wrap 1503 includes two layers of packaging material wrapped around the item. Second wrap 1505 includes one layer of packaging material wrapped around first wrap 1503 such that second wrap 1505 covers the unwrapped sides of first wrap 1503. As shown in FIG. 13A, the flute direction F in first wrap 1503 and second wrap 1505 is the same. One of the advantages of this embodiment is high in-plane crush resistance (defined as resistance to a load applied along the z-axis, perpendicular to the x-y plane).

Packaging construction 1500B of FIG. 13B includes a first wrap 1503 and a second wrap 1505. First wrap 1503 includes a double layer of packaging material wrapped around the item. Second wrap 1505 includes one layer of packaging material wrapped around first wrap 1503 such that second wrap 1505 covers the unwrapped sides of first wrap 1503. As such, first and second wraps 1503 and 1505, in combination, are in two of the three axis (x, y, and z) of the item (meaning that first wrap is in one of the three axis and second wrap is in another of the three axis). As shown in FIG. 13B, the flute direction (F) of first wrap 1503 is generally perpendicular to the flute direction (F) of second wrap 1505. One of the advantages of this embodiment is high crush resistance in the vertical axis.

Packaging construction 1500C of FIG. 13C includes a first wrap 1503, a second wrap 1505, and a third wrap 1507. First wrap 1503 includes a single layer of packaging material wrapped around the item. Second wrap 1505 includes one layer of packaging material wrapped around first wrap 1503 such that second wrap 1505 covers the unwrapped sides of first wrap 1503. Third wrap 1507 includes one layer of packaging material wrapped around second wrap 1505 such that it is perpendicular to both first wrap 1503 and second wrap 1505. As such, first, second, and third wraps 1503, 1505, and 1507, in combination, are in all three of the three axes (x, y, and z) of the item (meaning that first wrap is in one of the three axis, second wrap is in another of the three axis, and third wrap is in the third of the three axis). As shown in FIG. 13C, the flute direction (F) of first wrap 1503 is generally perpendicular to the flute direction (F) of second wrap 1505 and the flute direction (F) of third wrap 1507 is generally perpendicular to the flute direction (F) of both first and second wraps 1503, 1505. This embodiment has excellent crush resistance because all three axes are protected by packaging material. In general, flutes are stiffer and stronger parallel to the flute axis. Having a layer of flutes parallel to each of the axes provides strength along all axes. As a result, the package construction may be laid down on any of its sides and still offer high crush resistance. Further, in this embodiment, no preferred orientation of the package is required to provide excellent crush resistance.

Some embodiments of the packaging materials and constructions of the present disclosure include one or more flap portions that provide a layer adjacent to the first and/or second attachment layers. One exemplary embodiment of such packaging materials was shown in FIGS. 10A-10C.

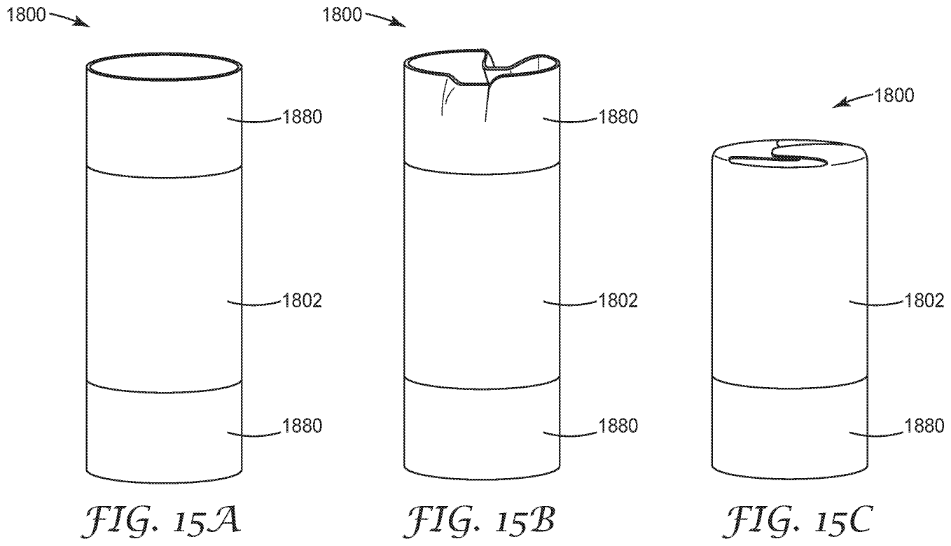

Those of skill in the art will appreciate that many changes to the above exemplary method can be made while still falling within the scope of the present disclosure. For example, some of the above steps are optional and, as such, the scope should be determined solely by the claims of the present disclosure. Further, any aspect of the end seal methods described herein (including, for example, those shown and described in FIGS. 15A-70C) can be included in the process or method of using embodiments with one or more flaps. Further, the cut off portion of the flaps can be scrunched or mashed into the edges of the cylinder to provide cushioning. Further, at least a portion of the flaps can be wrapped around the cylindrical package to can act as a writable, non-tacky surface that the user can use to address the packaging construction (e.g., write the “to” and “from” information).

Many packaging construction embodiments of the present disclosure involve wrapping the item in a single direction. This results in portions of the resulting packaging construction being open or exposed. Various options exist for how to seal these open ends of the packaging construction. Various exemplary options for closing and/or sealing these open or exposed areas of the packaging construction are shown in FIGS. 15-18. The packaging constructions in FIGS. 15-18 are shown as cylinders, but those of skill in the art will appreciate that any shape or size packaging construction can use the principles articulated below.

FIGS. 15A-15C schematically show one exemplary method of closing or sealing the upper and lower ends of the resulting cylinder of packaging construction 1800. In this embodiment, one or more stiffening portions 1880 extend beyond the multilayer packaging material portion 1802. The user then folds the liner portion 1880 inward, over the multilayer packaging material portion 1802 to securely seal the ends of the package construction 1800. In some embodiments, liner portion 1880 includes an attachment portion on its inner surface so that the attachment portion attaches, bonds, or adheres liner portion 1880 to the packaging material portion 1802. In other embodiments, liner portion 1880 does not include an attachment mechanism and the user uses tape or another separate attachment means to adhere the liner portion 1880 in position. Those of skill in the art will recognize that many changes may be made to this construction while still falling with the scope of the present disclosure. For example, the flap folding pattern may vary.

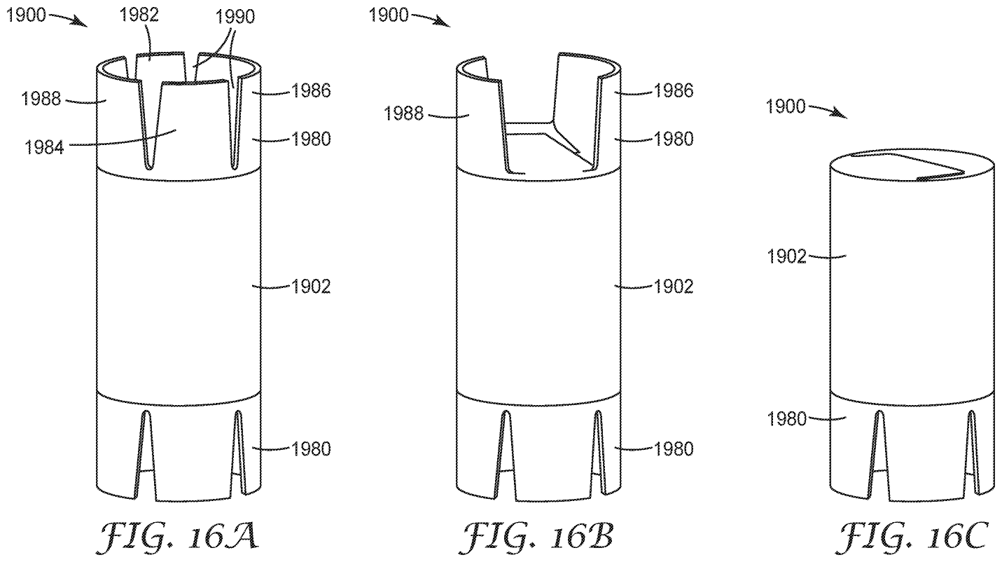

FIGS. 16A-16C schematically show another exemplary method of closing or sealing the upper and lower ends of the resulting cylinder of packaging construction 1900. Similar to the construction of FIGS. 16A-16C, one or more liner portions 1980 extend beyond the multilayer packaging material portion 1902. In the specific implementation of FIGS. 16A-16C, liner portion 1980 includes four flaps 1982 (first flap), 1984 (second flap), 1986 (third flap), and 1988 (fourth flap) that are at least partially separated from one another by one or more slits 1990. Flaps 1982, 1984, 1986, and 1988 can be pre-cut into the packaging material or can be formed/cut by the user. The user folds first flap 1982 downwardly onto the cylinder of multilayer packaging material portion 1902. Then, the user folds second flap 1984 downwardly onto or adjacent to first flap 1982. Next, the user folds third flap 1986 onto or adjacent to second flap 1984. Lastly, the user folds fourth flap 1988 onto or adjacent to third flap 1986. This process is repeated on the other end(s) of the package.

In some embodiments, liner portion 1980 includes an attachment layer on its inner surface so that the attachment layer facilitates attachment of one or more of the flaps to the packaging material 1902 or to the flap onto which another flap is attached, bonded, or adhered. In other embodiments, liner portion 1980 does not include an attachment mechanism and the user uses tape (or another separate attachment device) to adhere the fourth (or final) flap in position. Those of skill in the art will recognize that many changes may be made to this packaging construction and method of use embodiment while still falling with the scope of the present disclosure. For example, more or fewer than four flaps can be used. Also, the flaps may be the same or differently sized or shaped than one another.

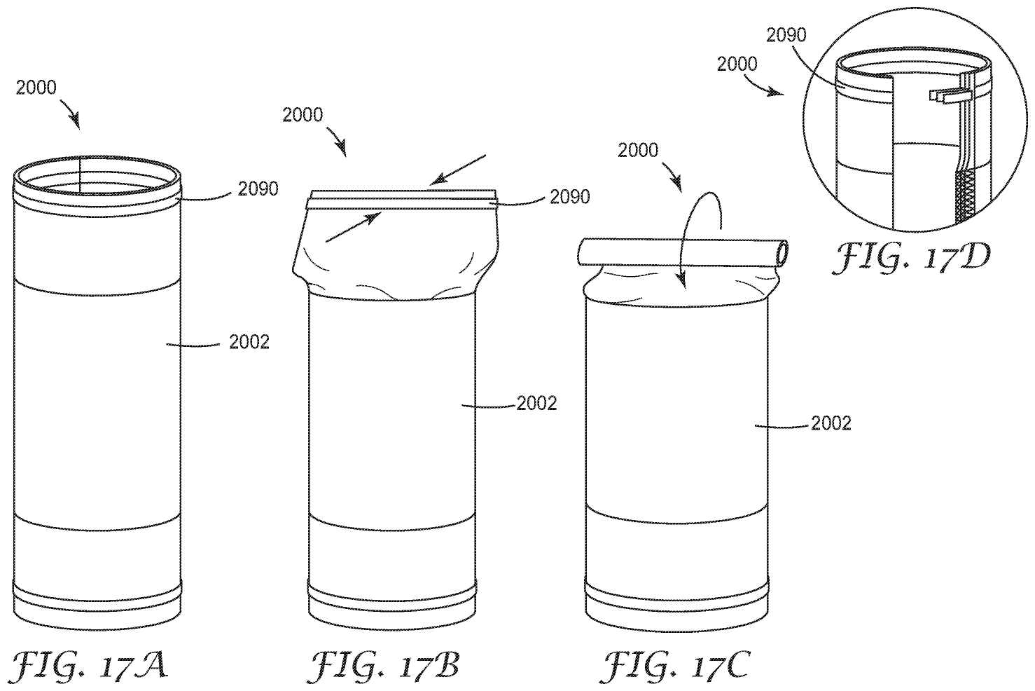

FIGS. 17A-17C schematically show another exemplary method of closing or sealing the upper and lower ends of cylindrical packaging construction 2000. Similar to the construction of FIGS. 15A-15C and 16A-16C, a stiffening layer or portion extends beyond the multilayer packaging material portion 2002 and forms a flap 2080. In the specific implementation of FIGS. 17A-17C, flap 2080 includes a twist-tie like feature 2090 that runs along the outer edge of the flap 2080. The flap can be pinched at the end and rolled downward toward the packaging material portion 2002 to seal the end of the packaging construction 2000. The twist-tie like feature can be any metal wire that is encased in a thin strip of paper or plastic and is used to secure by twisting. In some embodiments, the twist-tie like feature includes a metal wire or metal wire encased in plastic that is capable of deforming and holding its shape when bent. Some exemplary commercially available twist tie features include paper or plastic twist-ties sold by U-Line, Peel and Stick ties sold by U-Line, or Twist-Ease™ ties sold by U-Line.

Those of skill in the art will recognize that many changes may be made to this construction while still falling with the scope of the present disclosure. For example, more or fewer than one flap can be used. A differing twist-tie like feature can be used.

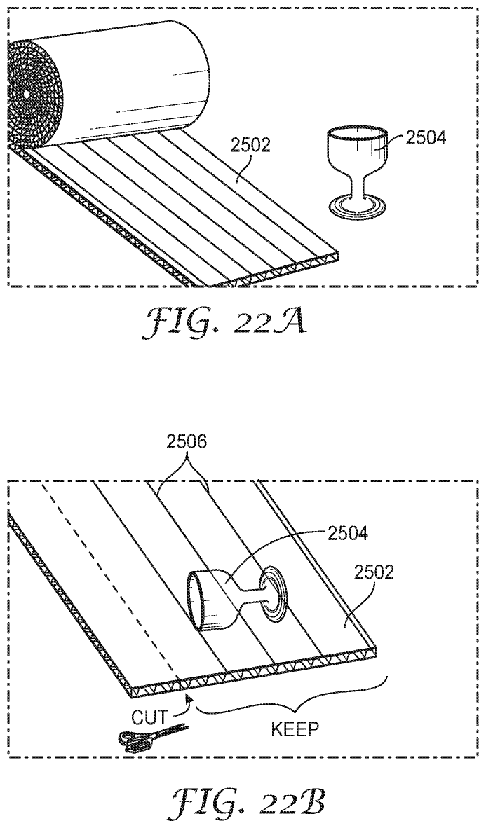

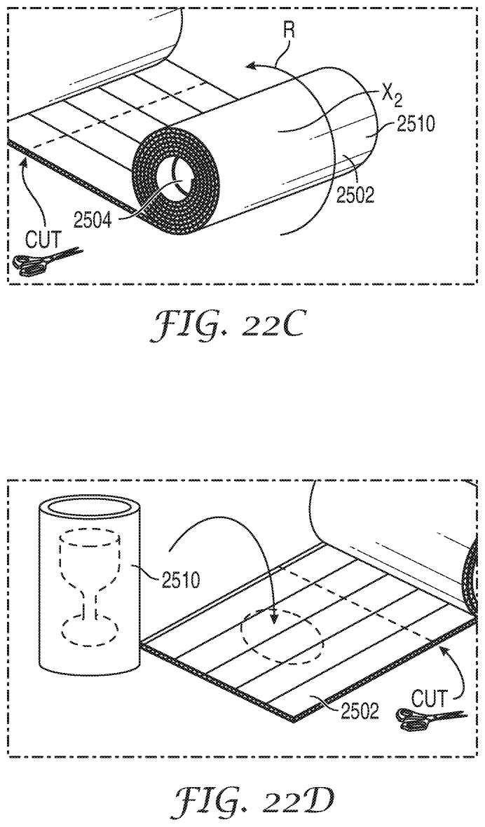

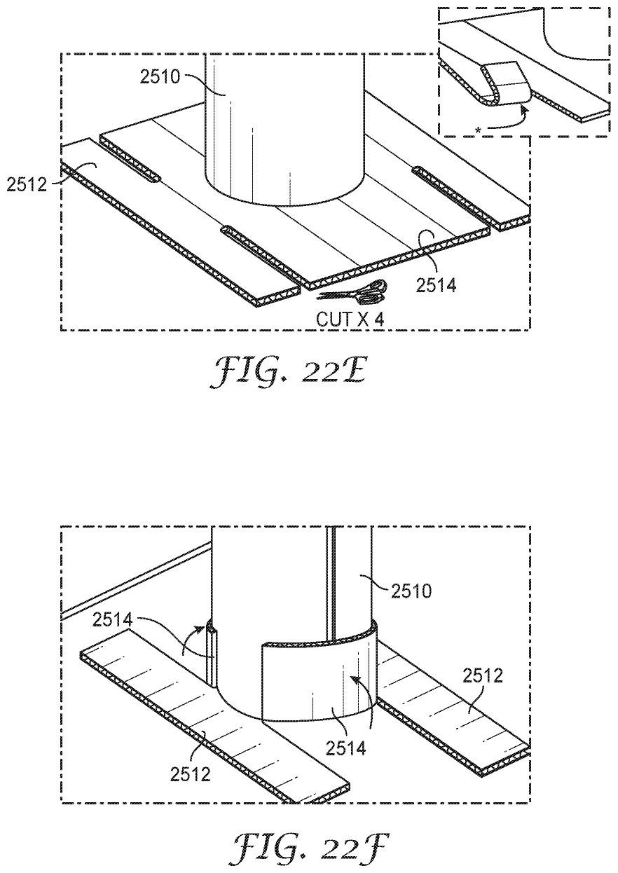

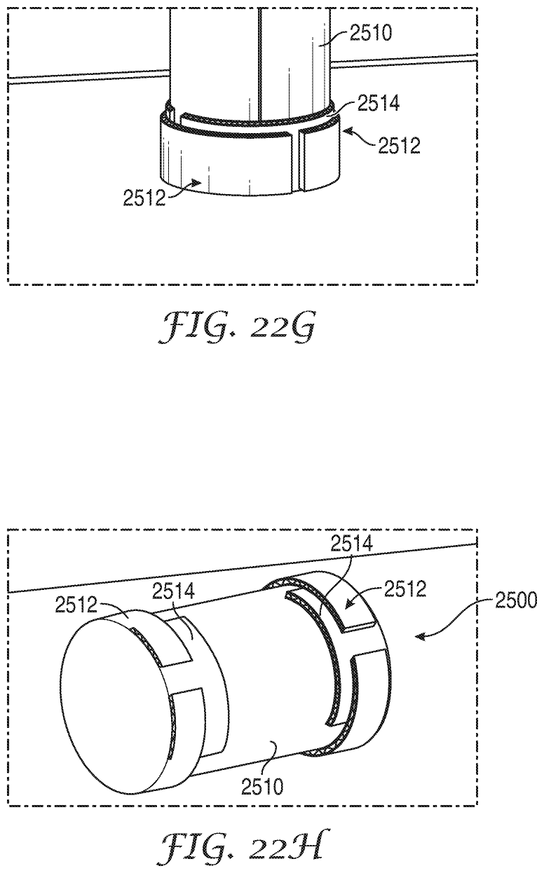

FIGS. 22A-22H schematically show another exemplary method of closing or sealing the upper and lower ends of an exemplary cylindrical packaging construction 2500. As shown in FIG. 22A, the packaging material 2502 is unrolled from its roll and (where present) the release liner is removed so that the corrugated material is upward/faces the user. As shown in FIG. 22B, the item 2504 is placed on packaging material 2502. In the specific implementation shown in FIG. 22B, the item 2504 is placed adjacent to the corrugated material such that the item is generally parallel to the flutes (not shown) of the corrugated material and is generally perpendicular to the segments 2506 (where present). In other embodiments (not shown), the item 2504 can be placed perpendicular or at any desired angle to the flutes and/or segments 2506 (where present). Optionally, the user can cut or remove a portion of packaging material 2502 (as shown by the scissors in FIG. 22B) so that the sides of the piece of packaging material more closely fits the size and/or shape of the item 2504. In some embodiments, one or more of the sides of the piece of packaging material 2502 are between about 2.54-12.7 cm—larger than the item. In some embodiments, one or more of the sides of the piece of packaging material 2502 are at least about 2.54 cm, or at least about 5.08 cm larger than the item on all sides of the item. The length of the piece of packaging material, however, is long enough to wrap around the item at least once, or, in some embodiments, at least twice.

As shown in FIG. 22C, the item 2504 and packaging material 2502 are then rolled along a roll direction R so that at least one (or, in some embodiments, at least two) layers of packaging material 2502 surround item 2504. In this specific implementation, this forms a generally cylindrical or tubular packaging construction 2510. In some embodiments, it is preferable to roll or wrap the item 2504 such that the diameter at the top of the cylinder or tube is approximately the same as the diameter at the bottom of the cylinder or tube. The shape of the packaging construction may be a shape other than a cylinder or tube, as any shape can result and, in some embodiments, will be dictated by the size and shape of the item. Some exemplary alternative shapes include rectangles, squares, triangles, quadrilaterals, polygons, etc.

FIG. 22D shows that the user then measures or approximates the diameter of the top or bottom of packaging construction 2510 and cuts a second piece of packaging material 2502 that is slightly larger than the diameter of the top or bottom of packaging construction 2510. In some embodiments, this second piece of packaging material 2502 is between about 2.54-12.7 cm larger than packaging construction 2510 on all sides of the packaging construction. In some embodiments, the second piece of packaging material 2502 is at least about 2.54 cm, or at least about 5.08 cm larger than the packaging construction 2510 on all sides of the packaging construction.

Next, as shown in FIG. 22E, packaging construction 2510 is placed on the second piece of packaging material 2502 such that the unwrapped portion of the packaging construction (in this exemplary embodiment, the top of bottom of the tubular or cylindrical packaging construction), is adjacent to the corrugated portion of the packaging material. The user then makes four cuts into (preferably along segments 2506) packaging material 2502 to form two flaps 2512 and two tabs 2514. Flaps 2512 may extend from the edge of packaging material 2502 to a location generally parallel or adjacent to the packaging construction 2510.

As shown in FIG. 22F, the user then folds the two tabs 2514 up and onto or adjacent to the packaging construction 2510. Because the packaging material 2502 of tabs 2514 includes a cohesive material, the user's hand pressure will enable tabs 2514 to adhere or stick to packaging construction 2510 with moderate to minimal hand pressure applied by the user.

Next, as shown in FIG. 22G, the user folds flaps 2512 up and onto or adjacent to tabs 2512 and/or the packaging construction 2510. Because the packaging material 2502 of flaps 2512 includes a cohesive material, the user's hand pressure will enable flaps 2512 to adhere or stick to packaging construction 2510 or tabs 2514 with moderate to minimal hand pressure applied by the user. In some embodiments, flaps 2512 can be adhered before tabs 2514, or flaps 2512 and tabs 2514 can be alternatively folded up and placed adjacent to one another or to the packaging construction.

The process of FIGS. 22D-22G can be repeated on the other open end of packaging construction 2510. In some embodiments, the packaging material 2502 used to seal or wrap the first end or open area has the same general position as the packaging material 2502 used to seal or wrap the second end or open area. For example, in some embodiments, the flutes of the packaging material 2502 used to seal or wrap the first end or open area are parallel to or aligned with the flutes of the packaging material 2502 used to seal or wrap the second end or open area. In other embodiments, the flutes of the packaging material 2502 used to seal or wrap the first end or open area are perpendicular to the flutes of the packaging material 2502 used to seal or wrap the second end or open area. The flutes and/or segments of the first and second piece of packaging material can be at the same or different angles relative to one another. Where the angles differ, they can be any angle relative to one another.

The resulting fully wrapped package or packaging construction 2500 is shown schematically in FIG. 22H.

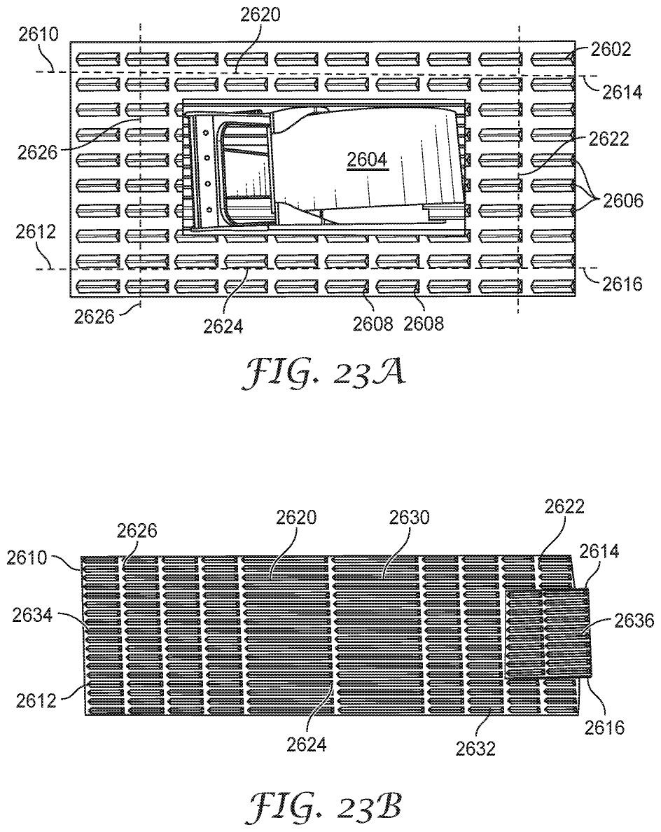

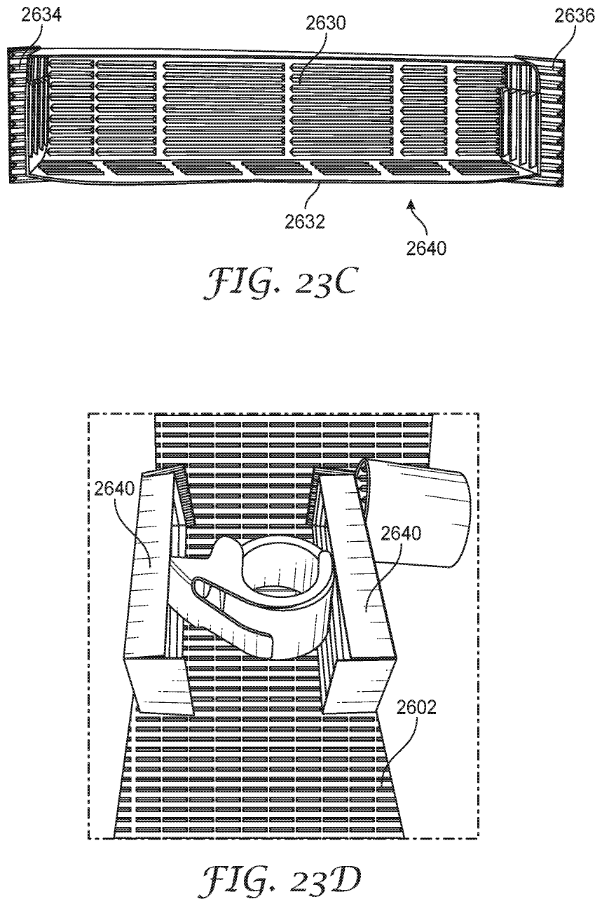

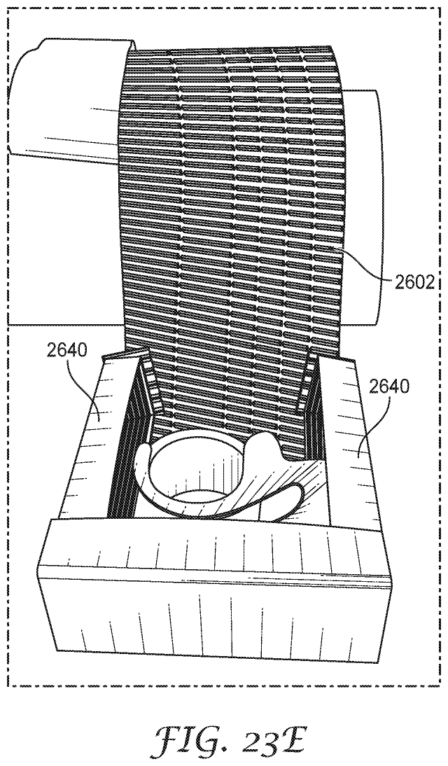

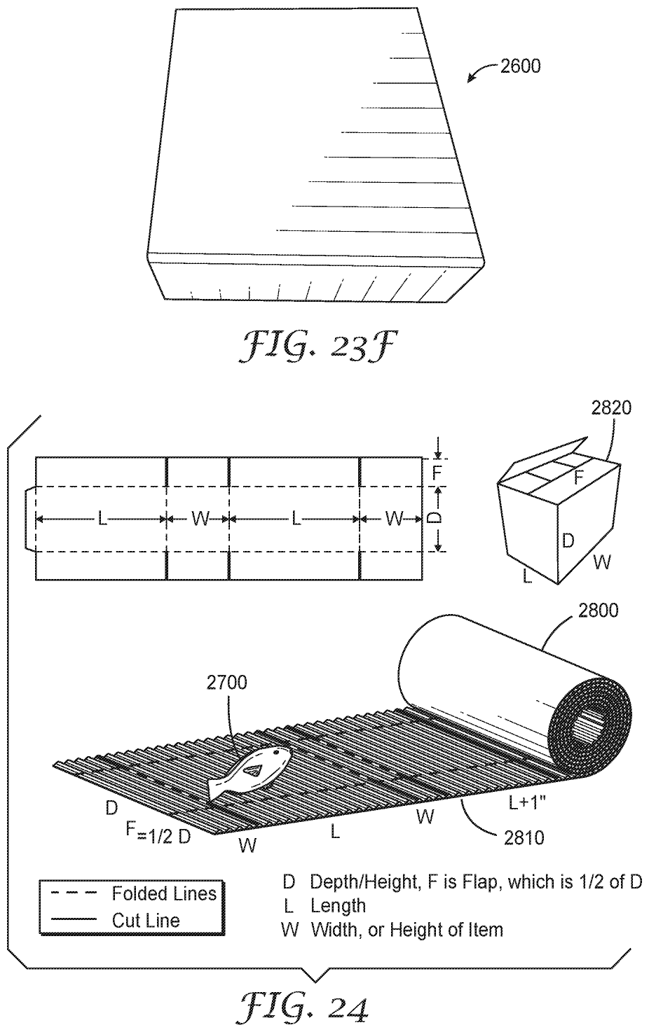

Those of skill in the art will recognize that many changes may be made to this packaging construction and method of use embodiment while still falling with the scope of the present disclosure. In general, a three-dimensional structure with closed or partially closed ends tends to exhibit higher crush resistance than one with open ends. The method and construction illustrated in FIG. 23 and FIG. 24.

For example, packaging constructions formed using this method have certain advantages. Packages or packaging constructions including these ends exhibit increased weight or load bearing capacity compared to existing applications and other wrapping methods described herein. In some embodiments, packages using this wrapping method have an over 90% increased load-bearing capacity, or an over 80% increased load-bearing capacity, or an over 70% increased load-bearing capacity, or an over 60% increased load-bearing capacity, or an over 50% increased load-bearing capacity compared to other wrapping methods described herein. In some embodiments, packages using this wrapping method have an over 5× increased load-bearing capacity, or an over 4× increased load-bearing capacity, or an over 3× increased load-bearing capacity, or an over 2× increased load-bearing capacity compared to other wrapping methods described herein. This increased load bearing capability is without requiring additional wrap layers.

FIGS. 23A-23F are photographs showing another exemplary packaging construction and/or another exemplary method of forming an exemplary packaging construction. As shown in FIG. 23A, an item 2604 is placed on the packaging material 2602. In the implementation shown in FIG. 23A, the item 2604 is placed such that the flutes 2606 are generally parallel and the segments 2608 are perpendicular (or at an angle) to the length of the item 2604. However, in other implementations, the item 2604 is placed such that the flutes 2606 are generally perpendicular (or at an angle to) and the segments 2608 are parallel to the length of the item 2604.

With the item 2604 on the packaging material 2602, the user measures or approximates between about 1.27 cm and about 5.08 cm larger than the item 2604 on all sides. This results in the rectangular piece of packaging material 2602 shown in FIG. 23A. Next, the user cuts slits 2610, 2612, 2614, and 2616 into the piece of rectangular packaging material 2602. The user then creates folds or creases along lines 2620, 2622, 2624, and 2626.

FIG. 23B show the resulting piece of packaging material 2602 which includes (1) a top flap or tab 2630 formed by crease 2620 and cuts 2614 and 2610, (2) a bottom flap or tab 2632 formed by crease 2616 and cuts 2612 and 2616; (3) a left or side flap or tab 2634 formed by crease 2626 and cuts 2610 and 2612, and (4) a right or side flap or tab 2636 formed by crease 2622 and cuts 2614 and 2616.

The user then folds top flap or tab 2630 and bottom flap or tab 2632 upward to form a generally 90 degree angle to packaging material 2602 and so that top flap or tab 2630 and bottom flap or tab 2632 contact and/or fold over one another on the sides, as shown in FIG. 23C. Next, left or side flap or tab 2634 and right or side flap or tab 2636 are folded upward to form a generally 90 degree angle to packaging material 2602 so that they generally cover or overlap at least a portion of top flap or tab 2630 and bottom flap or tab 2632, as shown in FIG. 23C. This process forms end cap 2640 shown in top view in FIG. 23C. This process is repeated to form a second end cap.

As shown in FIG. 23D, the two end caps 2640 are then placed on top of and generally along the lengthwise terminal sides of a second piece of packaging material 2602 such that the corrugation of the packaging material 2602 faces upward/toward the end caps 2640 and item 2604. It may be preferable to trim the packaging material to have a width that approximates the width of the item 2604 (as shown in FIG. 23D).

As shown in FIG. 23E, the user then folds the second piece of packaging material 2602 upward onto and around end caps 2640 to form a box-shaped packaging construction 2600. Packaging construction 2600, in its finished form, is shown in FIG. 23F. In some embodiments, only a single wrap or layer of second piece of packaging material 2602 around end caps 2640 is used. In other embodiments, two or more wraps or layers of packaging material 2602 around end caps 2640 are used. In some embodiments where a second wrap or layer is used, the second wrap or layer is aligned with (the flutes of the corrugate are aligned generally parallel to) the first wrap or layer. In other embodiments, the second wrap or layer is perpendicular or aligned at a non-parallel angle to the first wrap or layer.

FIG. 24 shows item 2700 placed on a portion 2810 or packaging material 2800, which here is in the form a roll wherein the portion 2810 is unrolled. After cutting the portion 2810 according to the schematic on the cut lines and folding the cut portion 2810 on the fold lines, a packaging structure 2820 is formed with width W, depth D and length L. The packaging structure 2820 can be closed like a box by way of flaps F and subsequently sealed by any suitable means, such as tape, adhesive (which may be pre-existing on portion 2810 or applied later), string, or the like.

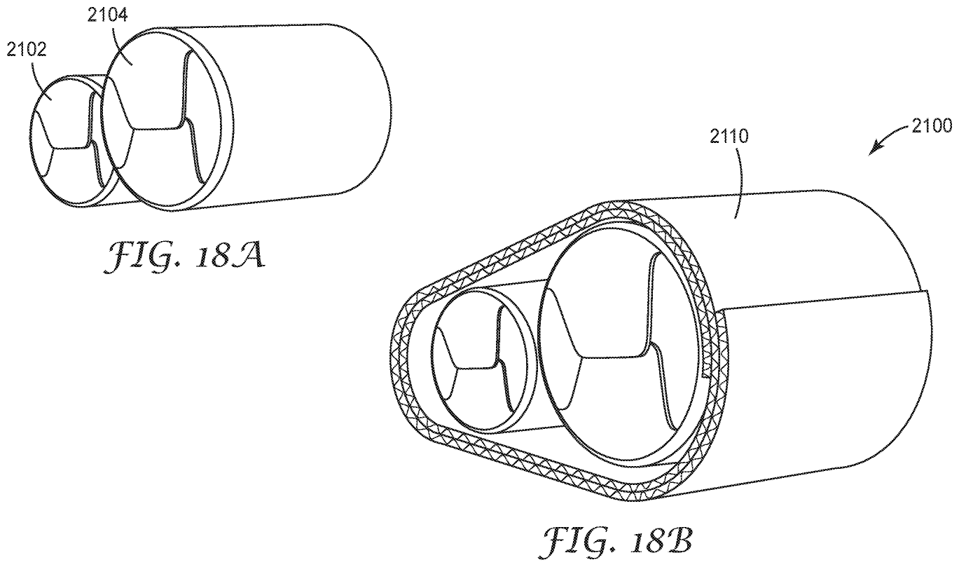

In some embodiments, multiple items can be wrapped with the packaging material or construction. One exemplary method of doing so is shown in FIGS. 18A and 18B. Two items 2102 and 2104 that have been wrapped using any method described herein, and particularly the method described with respect to FIGS. 16A-16C, are placed next to one another. The two items are then wrapped again and together using the packaging material 2110 and wrapping methods described herein to form packaging construction 2100. In some embodiments, the packaging material used to wrap items 2102 and 2104 differs from the packaging material 2110 used to form packaging construction 2100. Specifically, in some embodiments, the packaging material used to wrap items 2102 and 2104 includes one or more pre-cut flaps whereas the packaging material 2110 does not.

Methods of Unwrapping the Packaging Construction:

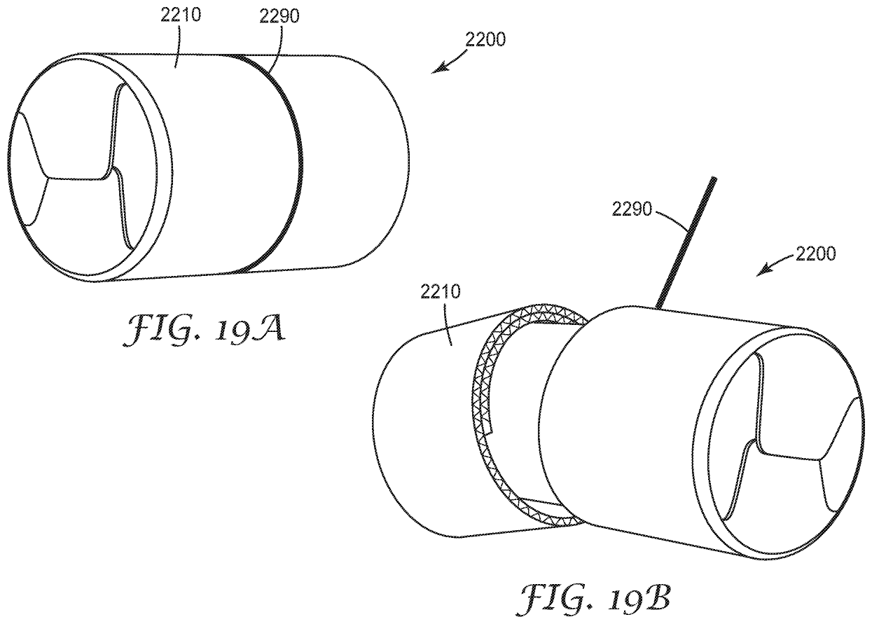

Opening or unwrapping the packaging material or construction is simple and intuitive. In some embodiments, the user can use a cutting device (e.g., scissors or a razor) to cut open the packaging construction in any desired location. One exemplary method of opening the packaging construction is shown in FIGS. 19A and 19B. In packaging construction 2200 of FIGS. 19A and 19B, a tear strip and/or cord 2290 is integrated in the packaging material 2210. In some embodiments, tear strip or cord 2290 is between the core portion and the stiffening portion. However, the tear strip or cord can be in any desired location. In some embodiments, tear cord or strip 2290 runs down the length axis of the packaging material and/or packaging construction. The packaging construction can be opened by pulling tear strip or cord 2290, which rips or cuts through packaging material 2210. Any material can be used for the tear strip or cord 2290 that has sufficient tensile strength to tear or rip through packaging material 2210. Examples of such materials include metal, glass fiber, and polymers. In some embodiments, the tear strip or cord has a tensile strength of at least about 30 MPa as measured according to ASTM 2343-03.

In embodiments that include gaps, channels, or segments of the type generally described with reference to FIGS. 11 and 12 above, the tear strip or cord can be placed in one of the gaps, channels, or spaces. In some embodiments, the tear strip or cord is placed in the gap, channel, or space that runs down the approximate center of the packaging material.

Those of skill in the art will recognize that many changes may be made to this construction while still falling with the scope of the present disclosure. For example, more than one tear strip or cord can be used. Also, any end seal pattern or process can be used other than that specifically shown.

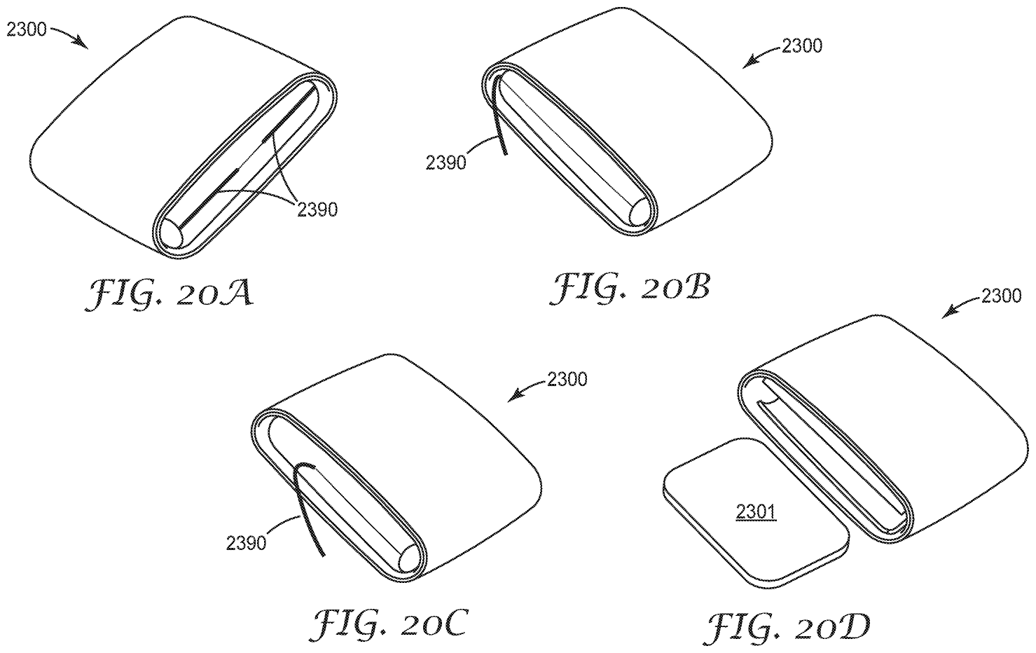

Another exemplary method of opening the packaging construction is shown in FIGS. 20A-20D. In packaging construction 2300 of those figures, the item 2301 is wrapped with packaging material as generally described herein. The packaging material includes one or more tear strips or cords 2390. The packaging construction can be easily opened along its side when the user pulls on the one or more tear strips. Item 2301 can then easily be removed. In some embodiments where the innermost wrap layer is a single layer, one advantage of this construction is that tearing or ripping through a single layer of packaging material with the rip cord is easier and faster than tearing through two or more wraps or layers of packaging material. In some embodiments, the tear strip or cord would be visible and easily accessible. The tear strip may be included in the packaging material or added by the user during item wrapping. Those of skill in the art will recognize that many changes may be made to this/these constructions while still falling with the scope of the present disclosure. For example, more than one tear strip or cord can be used. Further, the package can be any shape and is not limited to the size and shape shown.

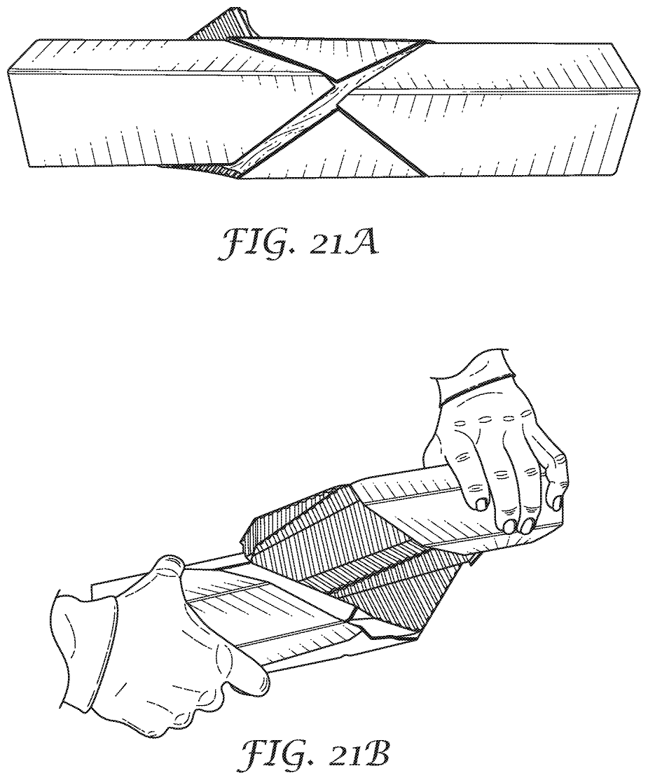

Another exemplary method of opening the packaging construction is shown in FIGS. 21A and 21B. In packaging construction 2400 of FIGS. 21A and 21B, the item (not shown) is wrapped with packaging material as generally described herein. The packaging material or construction includes an easy-open feature or area including, for example, a scored or perforated zone 2410 of, for example, generally x-shaped lines that facilitate easy opening. Specifically, as shown in FIG. 21B, the user grasps each terminal end of the packaging construction 2400 and twists them in opposite or opposing directions to cause the packaging construction to open in the area of the easy-open feature and/or scored or perforated zone. Those of skill in the art will appreciate that many changes may be made to the above embodiment while still falling within the scope of the present disclosure. For example, the easy-open area or zone is shown as including x-shaped score or perforation lines, but the area can include lines or scores of any shape or pattern, including, for example, a single line, etc.

Method of Making the Packaging Material

The packaging materials and constructions of the present disclosure can be made in a variety of ways. Some exemplary processes are as follows.

In some embodiments, a core portion is adhered, attached, or bonded to a stiffening portion using an attachment device such as, for example, adhesive. The resulting structural assembly is coated with first and second attachment layers.

In some embodiments, first attachment portion is applied to at least a portion of core portion and second attachment portion is applied to at least a portion of the stiffening portion. The core portion and stiffening portion are then adhered, attached, or bonded to one another using an attachment device such as, for example, adhesive.

Corrugated Core Portions:

Some embodiments of the present disclosure include a corrugated core portion. Various manufacturing methods for making such embodiments include those exemplary methods described below.

In one exemplary embodiment, a core portion is adhered, attached, or bonded to a stiffening portion using an attachment device such as, for example, adhesive. One or more segments are formed in the resulting structural assembly. First and second attachment portions are then applied to the first and second major surfaces of the structural assembly. A liner material is then applied to the resulting packaging material and the construction is wound onto a roll.

In another exemplary embodiment, second attachment portion is applied to one major surface of the stiffening portion by, for example, extrusion, flood coating, lamination, co-extrusion, etc. First attachment portion is applied to the corrugated major surface of core portion. The core portion and stiffening portion are then adhered, attached, or bonded to one another using an attachment device such as, for example, adhesive. Where present, segments are then formed in the packaging material as described herein. Where present, a liner is applied to the resulting packaging material and the construction is wound onto a roll.

In another exemplary embodiment, second attachment portion is applied to a major surface of the stiffening portion. First attachment portion is applied to a major surface of core portion. The first attachment portion/core portion combination is then slit or cut into segments. The segments are placed in the desired spacing and/or orientation. The stiffening portion/second attachment portion combination is then adhered, attached, or bonded to the core portion/first attachment portion combination using an attachment device such as, for example, adhesive. Where present, a liner is applied to the resulting packaging material and the construction is wound onto a roll.

In embodiments with pre-made flaps, any of the above processes may be used. In all such processes, the stiffening layer is wider than the core portion such that one or more areas of the packaging material include stiffening portion without core portion. These areas form the flaps. In some embodiments, at least one major surface of one or more flaps are coated with or include an attachment portion (e.g. any of the attachment portions described herein as first or second attachment portions). In such embodiment, the flap major surface facing upward or toward the core potion is coated with or includes the attachment portion. In some embodiments, the flaps are not coated with or do not include an attachment portion. In some embodiments, the flap portion is folded inward toward the core portion and the resulting packaging material can be wound onto a roll. In some embodiments, the flaps act as a liner and no additional liner or release layer is needed. In some embodiments, a release layer or liner is added.

Roll:

The packaging materials of the present disclosure can be made in, for example, a roll or a flat sheet. In embodiments where the construction is made and/or stored as a roll or roll good and where the first and second attachment layers or portions are cohesive and only substantially adhere or attach to themselves, when the packaging material is rolled up, a release liner or layer may be present to ensure that the coated surfaces do not make contact.

Properties of the Overall Packaging Construction

In some embodiments, the bending stiffness of the packaging material can be tuned to the desired amount by varying the materials and design of the structural assembly components—the stiffening portion and/or the core portion. Bending stiffness of the final packaging construction is determined by numerous factors including, for example, the packaging material, the number of layers used, and the overall geometry of the package. Further, maximum bending stiffness is not always the desired outcome. For example, a stiffer packaging material could yield a stiffer packaging construction, but this property must be balanced with ease of use including, for example, ease in cutting, wrapping, weight, etc. Further, not all item require the same level of crush protection/package bending stiffness.

Some embodiments of the packaging materials described herein are generally based on the principle of a sandwich composite or structure consisting of four main components: two high tensile modulus stiffening portions bonded to a low compressibility, lightweight, core portion using a high stiffness and/or strength attachment portion. In some embodiments, the sandwich composite includes only three main components: two structural assemblies that offer the high tensile modulus stiffening portion properties as well as the low compressibility, lightweight, core portion properties and a high stiffness attachment portion. When flexed or bent, one of the high tensile modulus stiffening portions is subjected to tension, and the other to compression. The degree of stress and strain on the high tensile modulus stiffening portions depends non-linearly on the spacing between them, which is provided by the core portion or by the structural assembly where the core portion and stiffening portions are combined into a single monolithic structure. The high tensile modulus of the stiffening portions resists strain and imparts bending stiffness to the packaging material structure. The components of the sandwich composite or structure work in concert to achieve the desired bending stiffness. In some embodiments of the present disclosure, a single layer of the packaging materials described herein is a partial sandwich structure consisting of a core portion and one of the two high tensile modulus stiffening portions.

Benefits:

The packaging materials and constructions of the present disclosure have many benefits. At least some of the benefits of these constructions or material are as follows. The packaging materials described herein provide equal or enhanced crush resistance such that an item is not damaged during transit while also providing one or more of the following additional advantages. The packaging construction occupies less space and/or has a smaller or lower profile than existing packaging constructions like boxes. Further, the packaging material can be customized to closely follow or mirror an items' shape or profile. As a result, the packaging materials take up less space during storage, both on store shelves and in a user's home or office. Further, they cost less to ship because of their reduced profile and/or size and/or their ability to mirror the item's shape or profile. This is not only a benefit to manufacturers and those paying for shipping, but it's also a sustainability benefit because less gas is being used and less pollution is being produced per shipment.

Further, the packaging materials and constructions described herein are capable of packaging articles of various sizes and shapes. The user has full control over the size and shape of the material used and the package created and the level of crush protection required for the specific item. In this way, the shippers or packages created can be truly custom-made and/or custom-fit. This also ensures that the item is fully protected without creating environmental waste and/or excess shipping cost.

The packaging material can be used in manual wrapping. This packaging material may be of great benefit to those who mail and ship goods relatively infrequently (e.g., the homemaker sending a care package or birthday gift a few times a year) as well as those individuals who frequently ship items through online sites or services like Etsy or eBay. This packaging material allows such users to store only a single packaging material that will work for all of their needs while ensuring safe and protected transit and deliver of their item.

In some embodiments, the packaging material can also be used in automated wrapping equipment, wherein the resultant package is automatically wrapped by a machine generally known in the art. Such use may be preferred by, for example, companies or corporations who manufacture or ship large volumes of goods. Use of this material would ensure protection of the goods but decrease shipping cost since a smaller package is being shipped while affording the same or better protection of the item. Further, the packaging material provides enhanced sustainability goals since environmental waste is reduced because (1) less air is being transported during shipment; and (2) less packaging is used to safely ship the item, resulting in less waste.

The following examples describe some exemplary constructions of various embodiments of the packaging constructions and methods of making the packaging constructions described in the present application. The following examples describe some exemplary constructions and methods of constructing various embodiments within the scope of the present application. The following examples are intended to be illustrative but are not intended to limit the scope of the present application.

### EXAMPLES

### Example 1

A 127 cm by 15.24 cm section of a single-face corrugated material ((Corrugated Wrap S-19397 (Corrugated Wrap Roll—B Flute) sold by Uline, Pleasant Prairie, Wis., USA)) was brush coated using a sponge brush over the entire surface of the flat side with a cohesive adhesive (Valpac™ CH265 sold by Valpac Inc., Federalsburg, Md., USA). On the corrugated side, only the tops of the flutes were brushed with the cohesive adhesive. This cohesive adhesive coated single-faced corrugated material was then used to form a tube by rolling along the major axis with the flat surface facing outward and the flutes running perpendicular to the long axis all the way to the other end of the 127 cm×15.24 cm section. The resulting tube sample had an inside diameter of approximately 8.9 cm and an outside diameter of 10.5 cm.

### Example 2

A 30.48 cm wide roll of Standard Paper (Boise Paper, Elk Grove Village, Ill., USA 110 lb. Index White Paper) was unrolled and the paper was thermally bonded to the flat side of a roll of single-face corrugated material ((Corrugated Wrap S-19397 (Corrugated Wrap Roll—B Flute) sold by Uline, Pleasant Prairie, Wis., USA) on a 30.38 cm roll) using a polyester web adhesive (Bostik PE103-20 sold by Bostik Inc., Wauwatosa, Wis., USA) and an iron (Rowenta Electric Iron Model DW8183 set at 140° C.). The flutes of the corrugated material ran perpendicular to the long axis of the resulting roll of single-faced corrugated material. Each major surface of the resulting roll of single-face corrugated material was then gravure coated (without the doctor blade attached) with cohesive adhesive (Valpac™ CH265 sold by Valpac Inc., Federalsburg, Md., USA) over the entire flat side and only the tops of the flutes on the corrugated side.

This roll of material was then used to create a hollow box-like structure using the following steps. A 10.16 cm wide section of material was cut from the 30.48 cm coated roll of cohesive-coated single-face corrugated material. A cylindrical glass jar measuring 17.46 cm long and 8.89 cm in diameter was placed upright on the corrugated side of the 10.16 cm section. The cohesive-coated corrugate material was then wrapped twice around the long axis of the glass jar to form the interior of the structure. The jar was then removed from the formed rectangular cardboard frame. The rectangular corrugate frame was then placed with the open-sided long axis lying down onto the corrugated surface of a second piece of 20.32 cm wide material cut from the original roll. The frame was then wrapped twice so that the open sides of the frame structure were covered, to form a hollow box like structure. The dimensions of the final structure were 20.32 cm×11.75 cm×12.065 cm (length×with×height). The sample was rotated 90 degrees about the long axis and was then tested.

### Example 3

A 30.48 cm wide roll of Standard Paper (Boise Paper, Elk Grove Village, Ill., USA 110 lb. Index White Paper) was unrolled and the paper was thermally bonded to the flat side of a roll of single-face corrugated material ((Corrugated Wrap S-19397 (Corrugated Wrap Roll—B Flute) sold by Uline, Pleasant Prairie, Wis., USA) on a 30.48 cm roll) using a polyester web adhesive (Bostik PE103-20 sold by Bostik Inc., Wauwatosa, Wis., USA) and an iron (Rowenta Electric Iron Model DW8183 set at 140° C.). The flutes of the corrugated material ran perpendicular to the long axis of the resulting roll of single-faced corrugated material. Each major surface of the resulting roll of single-face corrugated material was then gravure coated (without the doctor blade attached) with cohesive adhesive (Valpac™ CH265 sold by Valpac Inc., Federalsburg, Md., USA) over the entire flat side and only the tops of the flutes on the corrugated side.

Using the same sized jar as used in example 2, a rectangular frame was created using a 10.16 cm wide piece of corrugate cut from the original roll. In this example, the jar was wrapped with a single layer of corrugate material. The jar was removed. The rectangular corrugate frame was then placed with the open-sided long axis lying down onto the corrugated surface of a second piece of 20.32 cm wide material cut from the original roll. The frame was then wrapped once so that the open sides of the frame structure were covered, to form a hollow box like structure. The formed box structure was placed upright onto a third piece of 10.16 cm wide corrugate material cut from the original roll. The box was then wrapped a third time with a single layer of corrugate material all the way around the long axis. The dimensions of the final structure were 22.22 cm by 11.75 cm by 10.54 cm (length×width×height).

### Examples 4, 5, and 6

A piece of Standard Paper (Boise Paper, Elk Grove Village, Ill., USA 110 lb. Index White Paper) was thermally bonded to the flat side of a roll of single-face corrugated material ((Corrugated Wrap S-19397 (Corrugated Wrap Roll—B Flute) sold by Uline, Pleasant Prairie, Wis., USA) on a 12 inch roll) using a polyester web adhesive (Bostik PE103-20 sold by Bostik Inc., Wauwatosa, Wis., USA) and an iron (Rowenta Electric Iron Model DW8183) at 140° C. to form a roll of 30.48 cm wide double sided cohesive coated corrugated material. The Standard Paper was bonded to the entire surface of the flat side of the 30.48 cm wide single face corrugated material. The flutes were aligned perpendicular to the long axis of the sample. Each surface of the roll material was then gravure coated (without the doctor blade attached) with cohesive adhesive (Valpac™ CH265 sold by Valpac Inc., Federalsburg, Md., USA) over the entire flat side and only the tops of the flutes on the corrugated side. The coated roll material was used to create rectangular test samples measuring 5.08 cm by 25.4 cm. For all these test samples the corrugate flutes were running perpendicular to the long axis. For Example 4, a single rectangle test sample was tested. For Example 5, two test samples were layered directly on top of each other such that the corrugated material/flutes faced downward on each sample. For Example 6, three test samples were layered directly on top of each other such that such that the corrugated material/flutes faced downward on each sample. All samples were conditioned at room temperature for 24 hrs. before testing.

### Comparative Example A

A 3.81 cm by 15.24 cm sample of hot melt adhesive (Surebonder™ DT-25 (All Purpose Stik™) sold by FPC Corporation, Wauconda, Ill., USA) was applied using a glue gun ((Model GM-180 SD sold by FPC Corporation (Wauconda, Ill., USA)) to the flat surface side of the end of a 101.6 cm by 15.24 cm section of single-face corrugated material ((Corrugated Wrap S-19397 (Corrugated Wrap Roll—B Flute) sold by Uline, Pleasant Prairie, Wis., USA)). The flat surface end with the adhesive was rolled toward the corrugate flutes to form a tube with an inner diameter of approximately 8.89 cm. The glue was allowed to bond the flat surface to the corrugate flutes and then the tube was rolled along the major axis with the flat surface facing outward and the flutes running perpendicular to the long axis all the way to the other end of the 101.6 cm×15.24 cm section. The final tube formed had an inner diameter of approximately 8.89 cm and an outer diameter of approximately 10.8 cm. The outside flap of the roll was secured with approximately 3.81 cm×15.24 cm region using the same hot melt adhesive and glue gun used to secure the first loop of the tube.

### Comparative Examples B, C, and D

A roll of 30.48 cm wide single faced corrugate ((Corrugated Wrap S-19397 (Corrugated Wrap Roll—B Flute) sold by Uline, Pleasant Prairie, Wis., USA)) was thermally bonding to a piece of Standard Paper (Boise Paper, Elk Grove Village, Ill., USA 110 lb. Index White Paper) using a polyamide web adhesive (Bostik PA-115 (thickness of 50) sold by Bostik Inc., Wauwatosa, Wis., USA) and an iron (Rowenta Electric Iron Model DW8183) at 140° C. The Standard Paper was bonded to the entire surface of the flat side of the 30.48 cm wide single face corrugated material. The flutes were aligned perpendicular to the long axis of the sample. The roll material was used to create rectangular test samples measuring 5.08 cm by 25.4 cm. For all these test samples the corrugate flutes were running perpendicular to the long axis. Each test sample once cut was coated with a pressure sensitive adhesive (3M Fastbond 49 Insulation Adhesive) on both sides of the test sample using a sponge brush and allowed to dry for 24 hours. For Comparative Example B, a single rectangle test sample was tested. For Comparative Example C, two test samples were layered directly on top of each other after the 24 hour PSA dry time was complete. For Comparative Example D, three test samples were layered directly on top of each other after the 24 hour PSA dry time was complete. All samples were then conditioned at room temperature for 24 hrs. before testing.

### Comparative Example E

A 15.24 cm×15.24 cm×15.24 cm piece of Corrugated Box Lightweight (32 ECT Corrugated Box (S-21014) sold by Uline, Pleasant Prairie, Wis., USA) was tested.

### Test Methods

Stiffness and Flexural Modulus

Stiffness and flexural modulus were tested according to ASTM D-2412-02 (2008).

Comparative Example A and Example 1 were tested according to the Stiffness and Flexural Modulus test. The results are reported in Table 1.

TABLE 1
Stiffness and Flexural Modulus

| | Stiffness | Flexural |
|---|---|---|
| | (kPa) | modulus (kPa) |
| Comparative | 1.17 | 681.9 |
| Example A | | |
| Example 1 | 16.20 | 9474.8 |

Compressive Resistance Test

Compressive resistance was tested according to ASTM D642-15.

The compressive resistance of Examples 2, 3 and Comparative Example E was measured.

Results are reported in Table 2.

TABLE 2
Compressive Resistance of Examples 2, 3, and Comparative E.

| | Compressive |
|---|---|
| Examples | Resistance (N) |
| Example 2 | 2767 |
| Example 3 | 2019 |
| Comparative | 1330 |
| Example E | |

Bending Stiffness Test

Bending Stiffness was tested using a modified version of ASTM D790-17. A loading nose with a radius of 12.7 mm instead of the 5 mm loading nose specified in the ASTM D790-17 test protocol was used. Section 6.1.2.2 of the test method outlines the allowable use of alternative loading noses.

Three samples each of Examples 4-6 and Comparative Examples B, C, and D were tested.

Results are reported in Table 3.

TABLE 3
Bending Stiffness Results

| | Bending |
|---|---|
| | Stiffness (Nm) |
| Example 4 | 0.06 |
| Comparative | 0.04 |
| Example B | |
| Example 5 | 1.66 |
| Comparative | 0.30 |
| Example C | |
| Example 6 | 3.10 |
| Comparative | 0.68 |
| Example D | |

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples or embodiments or implementations (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Those having skill in the art will appreciate that many changes may be made to the details of the above-described embodiments and implementations without departing from the underlying principles thereof. Further, various modifications and alterations of the present disclosure will become apparent to those skilled in the art without departing from the spirit and scope of the invention. Thus, the following claims are hereby incorporated into the Detailed Description as examples or embodiments, with each claim standing on its own as a separate embodiment, and it is contemplated that such embodiments can be combined with each other in various combinations or permutations. The scope of the present disclosure should, therefore, be determined only by the following claims and equivalents thereof.

1. A packaging material, comprising:
a first attachment portion having a first major surface and a second major surface;
a core portion having a first major surface and a second major surface; the first major surface of the core portion adjacent to the second major surface of the first attachment portion;
a stiffening portion having a first major surface and a second major surface, the first major surface of the stiffening portion adjacent to the second major surface of the core portion; and
a second attachment portion having a first major surface and a second major surface; the first major surface of the second attachment portion adjacent to the second major surface of the stiffening portion wherein the first and second attachment layers include cohesive or are cohesive.

2. (canceled)

3. The packaging material of claim 1, wherein the core portion includes at least one of paper, film, plastic, polymeric material, molded pulp, a non-woven material, a woven material, foam, a corrugated material, corrugated paper, natural fibers, polymers, inorganic materials, metals, a lightweight or open structure, a net, a scrim, a web, or combinations thereof.

4. The packaging material of claim 3, wherein the packaging material is a corrugated material including a plurality of flutes that are spaced by between about 66 flutes/m and about 591 flutes/m.

5. The packaging material of claim 1, wherein the core portion is one of a monolithic structure and a multilayer construction.

6-7. (canceled)

8. The packaging material of claim 1, wherein the core portion has a thickness of between about 0.04 cm and about 2.54 cm.

9. (canceled)

10. The packaging material of claim 1, wherein the stiffening portion includes at least one of a film, a non-woven, a wovens, a net, a mesh, a scrim, a natural fiber, paper, a polymer, plastic, an inorganic material, fiberglass, or a metal, a metal foil, or combinations thereof.

11. The packaging material of claim 1, wherein the stiffening portion has a tensile modulus of at least about 100 MPa when measured according to ASTM D828-16.

12. The packaging material of claim 1, wherein the stiffening portion has a tensile strength of at least about 0.1 MPa when measured according to ASTM D828-16

13. The packaging material of claim 1, wherein the stiffening portion has a thickness of between about 0.006 mm and about 0.762 mm.

14. The packaging material of claim 1, wherein the core portion and the stiffening portion comprise a structural assembly and wherein the structural assembly is one of a monolithic unit, a multilayer construction, or a multicomponent construction.

15-19. (canceled)

20. The packaging material claim 1, wherein the first and second attachment portions are the same as one another.

21. The packaging material of claim 1, wherein the first and second attachment portions are different than one another.

22. (canceled)

23. The packaging material of claim 1, wherein at least one of the first and second attachment portions includes a cohesive material that has at least one of:
(a) a tack of less than 30 grams when measured according to ASTM D2979; or
(b) less than 20 wt % tackifier.

24-32. (canceled)

33. The packaging material of claim 1, wherein at least one of the first or second attachment portions covers or is directly adjacent to at least 75% of the surface area of at least one of the core portion, the stiffening layer, or the structural assembly.

34. The packaging claim 1, wherein at least one of the first or second attachment portions is discontinuous across the surface area of at least one of the core portion, the stiffening layer, or the structural assembly.

35. The packaging material of claim 34, wherein the discontinuities have a size of less than 10 times the thickness of the packaging material.

36-43. (canceled)

44. The packaging material of claim 1, wherein a first layer of packaging material and a second layer of packaging material are directly adjacent to one another to form a packaging construction; the packaging construction including the first attachment portion of the second layer of packaging material directly adjacent to and/or contacting the second attachment portion of the first layer of packaging material.

45. The packaging material of claim 44, wherein the packaging construction deflects by less than 7.62 cm when under a load of about 18.14 kg.

46. The packaging material of claim 44, wherein a 5.08 cm by 15.24 piece of packaging material, supported at the short edges, has a bending stiffness in at least one direction of less than 0.11 Nm as measured by ASTM D790-17; and the packaging construction has a bending stiffness of at least five times the bending stiffness of the packaging material as measured by ASTM D790-17.

47. The packaging material of claim 41, wherein a 5.08 cm by 15.24 cm piece of packaging material, supported at the short edges, has a bending stiffness in at least one direction of less than 0.06 Nm as measured by ASTM D790-17; and the packaging construction has a stiffness of at least ten times the stiffness of the packaging material as measured by ASTM D790-17.

48-70. (canceled)
